(19) United States
(12) Patent Application Publication
(10) Pub. No.: US 2025/0346719 A1
(43) Pub. Date: Nov. 13, 2025

(54) POLYMER MANUFACTURING PROCESS USING A POLY(ARYLETHERSULFONE) AS A REACTANT

(71) Applicant: Solvay Specialty Polymers USA, LLC, Alpharetta, GA (US)

(72) Inventors: Atul BHATNAGAR, Alpharetta, GA (US); Girish Chandra BEHERA, Alpharetta, GA (US); Saptarshi CHATTERJEE, Vadodara (IN); Gregory GOSCHY, Cumming, GA (US); Kamlesh P. NAIR, Alpharetta, GA (US); Hemanshubhai PATEL, Vadodara (IN); Vijay GOPALAKRISHNAN, Cumming, GA (US); Theodore MOORE, Suwanee, GA (US)

(21) Appl. No.: 18/871,171

(22) PCT Filed: Jun. 14, 2023
(86) PCT No.: PCT/EP2023/065912

§ 371 Date: Dec. 3, 2024

(30) Foreign Application Priority Data
Jun. 15, 2022 (IN) 202221034350
Sep. 9, 2022 (EP) 22194749.2

(51) Int. Cl. C08G 75/23; C08G 75/205; C08J 11/04

(52) U.S. Cl. CPC C08G 75/23; C08G 75/205; C08J 11/04; C08J 2381/06

(57) ABSTRACT

A process for the manufacture of a polyarylethersulfone “PAES” (P2) using recycled polymeric material, comprising heating a reaction medium (RM) comprising a recycled polymeric material containing a polyarylethersulfone “PAES” (P1), at least one monomer (M), an alkali salt-forming agent (A) and a polar aprotic solvent (S) to reach a reaction temperature of at least 150° C. to form a PAES (P2); and separating the forned PAES (P2) from the reaction medium. The PAES (P1) recycle ratio may be from 100 wt. % to 1 wt. %. The recycled polymeric material added to the reaction medium may further include other polymer(s), solid fillers, and/or additives. The monomer (M) may be at least one aromatic diol monomer (AA) and/or at least one aromatic dihalo monomer (BB). The diol (AA) may comprise bisphenol A, bisphenol S, biphenol, a 1,4:3,6-dianhydrohexitol sugar diol and/or tetramethyl bisphenol F, and the dihalo (BB) may comprise non-sulfonated and/or disulfonated dihalodiphenylsulfone.

### CROSS-REFERENCE TO RELATED APPLICATIONS

This application claims priority to Indian patent application No. 202221034350 filed on Jun. 15, 2022 and European patent application No. 22194749.2 filed on Sep. 9, 2022, the whole content of these applications being incorporated herein by reference for all purposes.

### TECHNICAL FIELD

The present disclosure relates to a chemical recycling process using a source of recycled polyarylethersulfone(s) as a reactant for manufacturing sulfone polymers.

### BACKGROUND ART

Products made from or incorporating plastic are a part of almost any workplace or home environment. Generally, the plastics that are used to create these products are formed from virgin plastic materials. That is, the plastics are produced from petroleum and are not made from existing plastic materials. Once the products have outlived their useful lives, they are generally sent to waste disposal or a recycling plant.

The omnipresence of plastics and the importance of environmental policy have led to the increased importance of recycled plastic materials. Virgin polymer composition replacement is considered to represent a significant way forward to solve the global plastic waste problem, stop the depletion of limited natural resources, and facilitate a circular economy. Recycling is one of the most significant actions which aims to reduce fossil oil usage, carbon dioxide emissions, the hazards associated with waste disposal, and the high rates of plastic pollution.

Recycling plastic has a variety of benefits over creating virgin plastic from petroleum. Generally, less energy is required to manufacture an article from recycled plastic materials derived from post-consumer and post-industrial waste materials and plastic scrap (collectively referred to in this specification as “waste plastic material”) than from the comparable virgin plastic. Recycling plastic materials obviates the need for disposing of plastic materials or products.

Generally, there are two ways to recycle plastics: physical recovery and chemical recovery. Mechanical recycling, also known as secondary recycling without changing the basic structure of the material, is a process of recovering waste plastic material for re-use in manufacturing plastic products via mechanical means. Compare with chemical recycling, when available in large amounts, clean and mono-type plastic is more ideal for mechanical recycling and a win-win situation from an environmental and economic perspective. However, the availability of clean and homopolymeric-based material for mechanical recyclability is low. Chemical (tertiary) recycling is a term used to refer to advanced technology processes which convert plastic materials into smaller molecules, usually, liquids or gases, which are suitable for use as a feedstock for the production of new petrochemicals and plastics. Hence, most previous methods for chemical recycling of polymer compositions include repurposing polymers by depolymerization into lower molecular weight products which can only be used in applications other than originally targeted.

Given the demand for improved sustainability and circular economy, recycling a polymer back into the same application for which it is intended is highly desired.

Such recycling would be viewed as efficient resource utilization where no waste is generated and the polymer is cycled back into the same application that generated it as waste (after its initial use) in the first place. Such a recycling process would be eco-friendly with high efficiency. This would be an improvement over incumbent technologies in which polymers are recycled for less demanding applications thus limiting their end-use. Polymers reuse in their originally intended application is in general quite limited.

The amorphous sulfone polymers are used successfully in modem industries such as automotive, electronic equipment, medical devices, and aerospace because the sulfone polymers exhibit a unique property profile that includes not only the benefits of high strength and temperature resistance but also inherent transparency in addition to other attributes. As a result, they are especially well qualified for all applications where traditional materials such as glass and metal are to be substituted.

Examples of sulfone polymers made using recycled polymer waste can be found in US 2016/002431A1 (IBM), the article by Hong et al (Green Chemistry, 2017, vol. 19, pp. 3692-3706), and the article by Jones et al (PNAS, Jul. 12, 2016, vol. 113 (28), pp. 7722-7726). These references describe the use of polycarbonate as a source of Bisphenol A to make sulfone polymers with difluorodiphenyl sulfone and a carbonate salt; the resulting polymer is a polysulfone polymer, structurally different than the base polycarbonate material PC which is used as a source of Bisphenol A monomer.

A process for making highly-branched polyarylene ether polymers from linear polyarylene ether polymers is disclosed in US2005154178A1 (Xerox). Such process comprises (A) providing a reaction medium which comprises (i) an optional solvent, (ii) a polyfunctional phenol compound of the formula Ar(OH)x wherein x≥3 and wherein Ar is an aryl moiety or an alkylaryl moiety, provided that when Ar is an alkylaryl moiety at least three of the —OH groups are bonded to an aryl portion thereof, (iii) one or more of linear polyarylene ether polymers. In Examples I-III, a linear polysulfone (PSU) is depolymerized and re-polymerization with a triol and cesium carbonate to yield a highly-branched polysulfone polymer for which the molecular weight is significantly reduced compared to the initial linear polysulfone (a 2.7-fold to 4.2-fold reduction in Mw) and its polydispersity index (PDI) is significantly increased which provides evidence of a much higher degree of branching of the polymer backbone. The resulting sulfone polymer is structurally different from its original linear polysulfone polymer. Moreover, this reference does not mention the recycling of polymeric waste.

### SUMMARY OF INVENTION

The invention is as disclosed below and in the appended claims.

The present invention addresses the recyclability of sulfone polymers where the polymer is effectively recycled by a one-pot process that scrambles the polymer recurring units and incorporates them into newly formed polymer chains from oligomers, and monomers in the reaction medium. Since monomers can be added to the reaction medium, the type of sulfone polymer obtained after this process may be identical in chemical structure and also in properties when the added monomers correspond to the same monomers from which the recycled sulfone polymer is derived. On the other end, when monomers added to the reaction medium yield a different type of sulfone recurring units, then the resulting polymer not only includes recurring units originating from the recycled sulfone polymer, but also other recurring units from the added monomers.

Another benefit is to reclaim virgin polyarylethersulfones produced in commercial plant operations or post-industrial polyarylethersulfone waste that do not meet certain product specifications, sometimes referred to as “off-specification” polyarylethersulfone (such as a high yellow color index, polymers generating hazy solutions, too low or too high Mw for a specific intended application such as unsuitable for forming films or fibers for membrane applications). This polyarylethersulfone waste that does not meet certain product specifications makes becomes unsalable and therefore many times are disposed of in a landfill.

By using this methodology the polyarylethersulfone manufacture commercial plants can achieve near 100% efficiency and reduce their environmental footprint while improving the production economics.

A first aspect of the present invention provides a process for producing a polyarylethersulfone (P2) using a recycled polymeric material comprising a polyarylethersulfone (P1) as a reactant, comprising
adding a polar aprotic solvent (S) to a reactor vessel;
adding a recycled polymeric material containing a polyarylethersulfone (P1) to the reactor vessel;
adding an alkali salt-forming agent (A) to the reactor vessel;
adding at least one monomer (M) selected from the group consisting of at least one aromatic diol monomer (AA) and at least one aromatic dihalo monomer (BB) to the reactor vessel;
whereby said adding steps form a reaction medium (RM) comprising the recycled polymeric material containing the polyarylethersulfone (P1), at least one monomer (M), the alkali salt-forming agent (A), and the polar aprotic solvent (S),
heating the reaction medium to reach a reaction temperature of at least 150° C. to form a polyarylethersulfone (P2); and
separating the formed polyarylethersulfone (P2) from the reaction medium; wherein the alkali salt-forming agent (A) is an alkali metal carbonate and/or an alkali metal hydroxide.

The aromatic diol monomers (AA) may be selected from the group consisting of 4,4′-biphenol, bisphenol A, bisphenol S, isosorbide, isomannide, isoidide, tetramethyl bisphenol F, hydroquinone, and any combination thereof, preferably selected from the group consisting of 4,4′-biphenol, bisphenol A, bisphenol S, tetramethyl bisphenol F, hydroquinone, and any combination thereof.

The aromatic dihalo monomer (BB) may be selected from the group consisting of 4,4′-difluorodiphenylsulfone (DFDPS), 4,4′-dichlorodiphenylsulphone (DCDPS), disulfonated DCDPS, disulfonated DFDPS, and any combination thereof, preferably selected from the group consisting of DCDPS, disulfonated DCDPS, and combination thereof.

The polyarylethersulfone (P1) is derived by condensation from at least one aromatic diol monomer (AA′) and at least one aromatic dihalo monomer (BB′), wherein:
the added aromatic diol monomer (AA) may be the same or different than the aromatic diol monomer (AA′);
the added aromatic dihalo monomers (BB) may be the same or different than the aromatic dihalo monomer (BB′).

A second aspect of the present invention relates to the PAES (P2) obtained by the process according to the present invention.

A third aspect of the present invention provides the use of the PAES (P2) for preparing an article (or a part thereof).

Another aspect of the present invention provides an article comprising the PAES (P2) according to the present invention.

### Disclosure of Preferred Embodiments of the Present Invention

In the present application:
any description, even though described in relation to a specific embodiment, is applicable to and interchangeable with other embodiments of the present disclosure, and each embodiment thus defined may be combined with another embodiment, unless otherwise indicated or clearly incompatible;
where an element or component is said to be included in and/or selected from a list of recited elements or components, it should be understood that in related embodiments explicitly contemplated here, the element or component can also be any one of the individuals recited elements or components, or can also be selected from a group consisting of any two or more of the explicitly listed elements or components; any element or component recited in a list of elements or components may be omitted from such list;
any recitation herein of numerical ranges by endpoints includes all numbers subsumed within the recited ranges as well as the endpoints of the range and equivalents;
the term “comprising” (or “comprise”) includes “consisting essentially of” (or “consist essentially of”) and also “consisting of” (or “consist of”); and
the use of the singular ‘a’ or ‘one’ herein includes the plural unless specifically stated otherwise; and
it should be understood that the elements, properties, and/or the characteristics of a (co)polymer, product or article, a process, or a use, described in the present specification, may be combined in all possible ways with the other elements, properties and/or characteristics of the (co)polymer, product or article, process or use, explicitly or implicitly, this being done without departing from the scope of the present description.

The term “consisting essentially of” in relation to a composition, product, polymer, solution, process, method, etc is intended to mean that any additional element or feature which may not be explicitly described herein and which does not materially affect the basic and novel characteristics of such a composition, product, polymer, solution, process, method, etc can be included in such an embodiment. For example, when a composition, compound, product, polymer, or solution “consists essentially of” required elements, it is generally understood that any additional element may be present in not more than 1 wt % based on the total weight of the composition, compound, product, polymer, solution, etc or not more than 1 mol % based on the total number of moles of the composition, compound, product, polymer or solution.

In the present disclosure, the term “recurring unit” designates the smallest unit of a PAES polymer which is repeating in the chain and which is composed of a condensation of a diol compound and a dihalo compound. The term“recurring unit” is synonymous to the terms “repeating unit” and “structural unit”.

As used herein, the term “homopolymer” encompasses a polymer which only has one type of recurring unit.

As used herein, the term “copolymer” encompasses a polymer which may have two or more different types of recurring units.

The term “solvent” is used herein in its usual meaning that, it indicates a substance capable of dissolving another substance (solute) to form a uniformly dispersed mixture at the molecular level. In the case of a polymeric solute, it is common practice to refer to a solution of the polymer in a solvent when the resulting mixture is transparent and no phase separation is visible in the system. Phase separation is taken to be the point, often referred to as the “cloud point”, at which the solution becomes turbid or cloudy due to the formation of polymer aggregates.

The term “membrane” is used herein in its usual meaning, that is to say, it refers to a discrete, generally thin, interface that moderates the permeation of chemical species in contact with it. A membrane generally comprises a polymer. Examples of membranes are water purification membranes and hemodialysis membranes.

The term “post-consumer” polymeric material (or article) refers to a finished good that is used and then recycled; this may provide a source of recycled polymeric material that can be used in the present method. The typical post-consumer polymeric material may include, but is not limited to, packaging, membranes, compounds, automotive components, electronic components, consumer product components such as but not limited to plastic bottles and particularly baby bottles, battery components, or any used or end-of-life three-dimensional injection-molded, extruded or printed articles or parts thereof.

The term “post-industrial” polymeric material (or article), also known as “pre-consumer” polymeric material (or article), refers to waste generated from manufacturing processes that lead to the creation of the source polymeric material which can be used in the present method. For example, when a polymer is formed into bottles, polymeric scraps may be generated and they do not end up in the final bottle products. If these polymeric scraps are ground, shredded, or re-pelletized, and used again in making the same article or another article, they will be referred to as “post-industrial” polymeric material. Typical pre-consumer polymeric material may include, but is not limited to, whole articles, parts thereof, or scraps thereof, of packaging, films, fibers, membranes, off-specification compounds, or polymeric products including off-specification polyarylethersulfones, automotive components, electronic components, consumer product components such as plastic bottles and particularly baby bottles, battery components, or any three-dimensional injection-molded, extruded or printed articles or parts thereof.

In other words, post-consumer polymeric material (or article or waste) refers to finished goods, while post-industrial polymeric material (or article or waste) refers to waste material generated from a manufacturing process that manufactures polymers or polymeric based articles.

The weight average molecular weight (Mw) and the number average molecular weight (Mₙ) may be estimated by gel-permeation chromatography (GPC) calibrated with polystyrene standards. The mobile phase may be selected from any solvent for the polymers described herein, for example, the solvent(s) described herein, such as methylene chloride, N-alkyl-2-pyrrolidone like N-Methyl-2-pyrrolidone (NMP), N-butyl-2-pyrrolidinone, etc., dimethyl sulfoxide (DMSO), 1,3-dimethyl-2-imidazolidinone (DMI), tetramethylene sulfone (sulfolane), N,N′-dimethylacetamide (DMAc) or any mixture thereof. The polydispersity index (PDI) is hereby expressed as the ratio of weight average molecular weight (M_{w}) to the number average molecular weight (Mₙ).

Should the disclosure of any patents, patent applications, and publications that are incorporated herein by reference conflict with the description of the present application to the extent that it may render a term unclear, the present description shall take precedence.

An aspect of the present invention relates to a method for chemically recycling a polymeric material comprising a polyarylethersulfone (P1) [hereinafter “PAES (P1)” ], comprising
adding a polar aprotic solvent (S) to a reactor vessel;
adding a polymeric material containing a PAES (P1) to the reactor vessel;
adding an alkali salt-forming agent (A) to the reactor vessel;
adding at least one monomer (M) selected from the group consisting of at least one aromatic diol monomer (AA) and at least one aromatic dihalo monomer (BB) to the reactor vessel;
whereby said adding steps form a reaction medium (RM) comprising the polymeric material containing the PAES (P1), the at least one monomer (M), the alkali salt-forming agent (A), and the polar aprotic solvent (S),
heating the reaction medium to reach a reaction temperature of at least 150° C. to form a polyarylethersulfone (P2) [hereinafter “PAES (P2)” ]; and
separating the formed PAES (P2) from the reaction medium;
   wherein
such PAES (P1) is derived by condensation from at least one aromatic diol monomer (AA′) and at least one aromatic dihalo monomer (BB′),
the aromatic diol monomer (AA) is the same or different than the aromatic diol monomer (AA′);
the aromatic dihalo monomers (BB) are the same or different than the aromatic dihalo monomer (BB′); and
the alkali salt-forming agent (A) is an alkali metal carbonate and/or an alkali metal hydroxide.

The aromatic diol monomers (AA) may be selected from the group consisting of 4,4′-biphenol, bisphenol A, bisphenol S, isosorbide, isomannide, isoidide, tetramethyl bisphenol F, hydroquinone, and any combination thereof, preferably selected from the group consisting of 4,4′-biphenol, bisphenol A, bisphenol S, tetramethyl bisphenol F, hydroquinone, and any combination thereof.

The aromatic dihalo monomer (BB) may be selected from the group consisting of 4,4′-difluorodiphenylsulfone (DFDPS), 4,4′-dichlorodiphenylsulphone (DCDPS), disulfonated DCDPS, disulfonated DFDPS, and any combination thereof, preferably selected from the group consisting of DCDPS, disulfonated DCDPS, and combination thereof.

In preferred embodiments, the polymeric material comprises at least one recycled material selected from the group consisting of post-consumer polymeric articles, post-industrial polymeric articles including article scraps, off-specification polyarylethersulfone products; and any combination thereof. These articles are preferably selected from the group consisting of membranes, automotive components, electronic components, consumer product components such as baby bottles, composites, battery components, and any combinations thereof.

### Polyarylethersulfone (P1)

The recycled polymer material used as a reactant in the process of the present invention comprises at least one polyarylethersulfone (P1).

The PAES (P1) may be a polymer comprising at least 50 mol. %, at least 60 mol. %, at least 70 mol. %, at least 80 mol. %, at least 90 mol. %, at least 95 mol. %, or at least 98 mol. %, based on the total number of moles of recurring units of PAES (P1), of at least one recurring unit selected from those of formulae (L), (L′), (M), (M′), (N), (N′), (O), (O′), (T), (T′), (U), (U′), (V), (V′), (W), (W′):

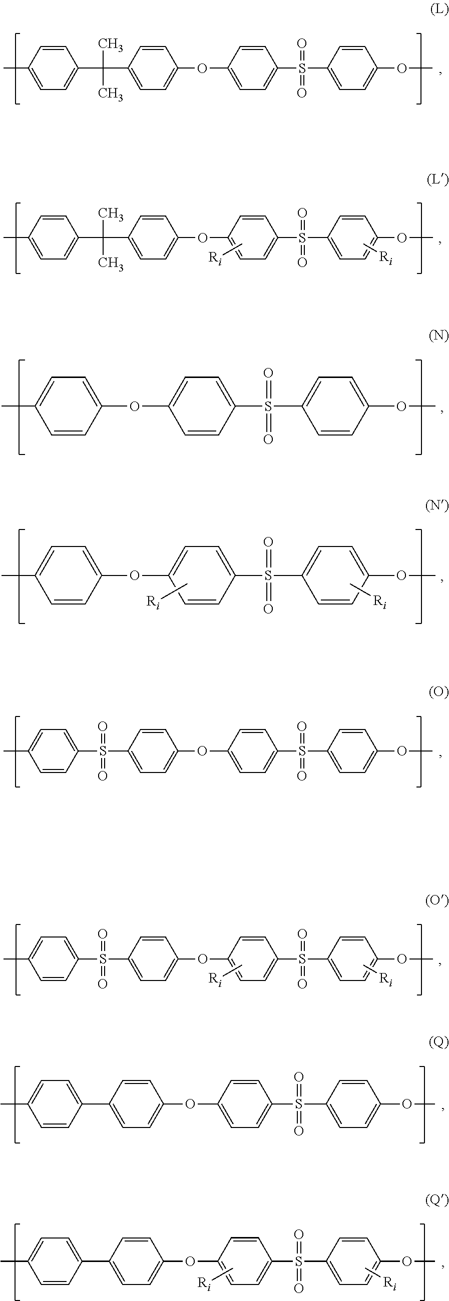

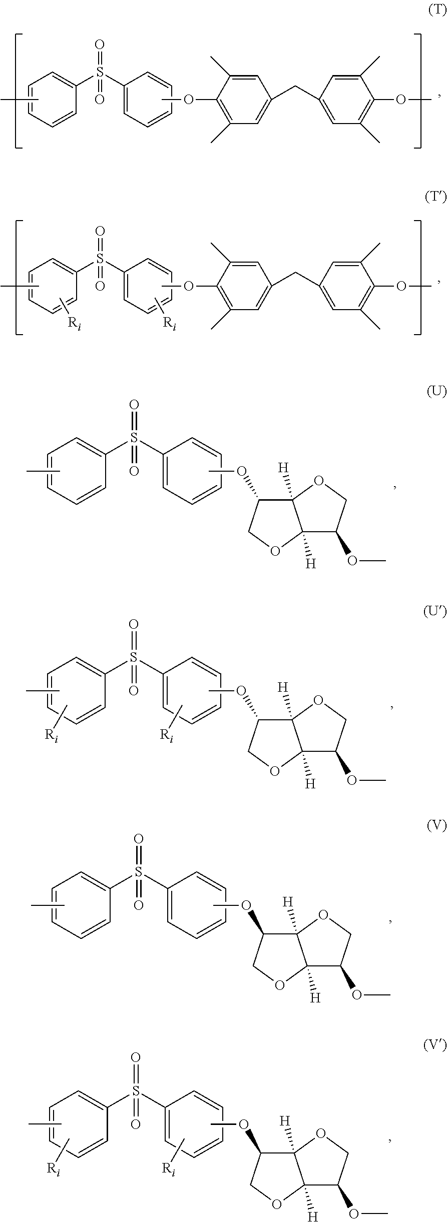

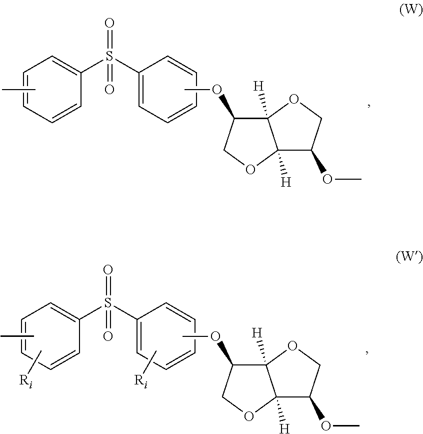

wherein:
   each R is independently selected from the group consisting of halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine, and quaternary ammonium; and
   each i is independently an integer of 1 to 4.

The recurring units selected from those of the formulae (U), (V), (W) may be represented by formulae (U*), (V*), (W*), respectively:

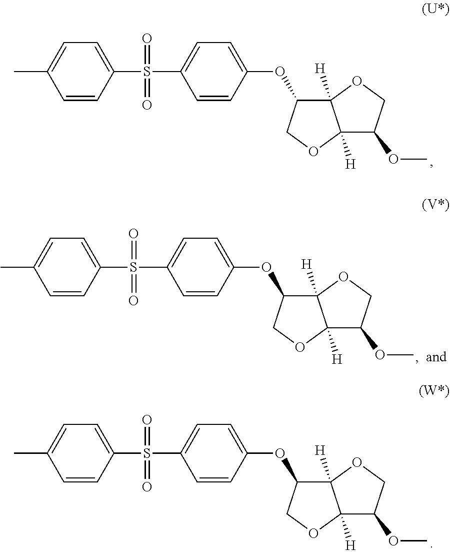

The PAES (P1) may be a homopolymer having one recurring unit selected from those of the formulae (L), (L′), (N), (N′), (O), (O′), (Q), (Q′), (T), (T′), (U), (U′), (V), (V′), (W), (W′), (U*), (V*), (W*), or may be a copolymer comprising two or more recurring units selected from those of the formulae (L), (L′), (N), (N′), (O), (O′), (Q), (Q′), (T), (T′), (U), (U′), (V), (V′), (W), (W′), (U*), (V*), (W*). In some embodiments, each R, in the recurring units selected from those of the formulae (L′), (N′), (O′), (Q′), (T′), (U′), (V′) and (W′) as provided above, may be independently selected from the group consisting of alkali or alkaline earth metal sulfonates and alkyl sulfonates, and each i is independently selected from integers from 1 to 4.

In particular, the PAES (P1) may be a copolymer comprising at least 60 mol. %, based on the total number of moles of recurring units in PAES (P1), or consisting essentially of,
the recurring units of formulae (L) and (L′),
the recurring units of formulae (N) and (N′),
the recurring units of formulae (O) and (O′),
the recurring units of formulae (Q) and (Q′),
the recurring units of formulae (T) and (T′),
the recurring units of formulae (U) and (U′),
the recurring units of formulae (V) and (V′), or
the recurring units of formulae (W) and (W′),
   in which each R, in the recurring units of formulae (L′), (N′), (O′), (Q′), (T′), (U′), (V′), and (W′), may be independently selected from the group consisting of alkali or alkaline earth metal sulfonates and alkyl sulfonates, and each i is independently selected from integers of 1 to 4

In a preferred embodiment in the process for producing a polyarylethersulfone (P2) using a recycled polymeric material comprising the polyarylethersulfone (P1) as a reactant, the PAES (P1) preferably comprises at least 50 wt. %, at least 60 wt. %, at least 70 wt. %, at least 80 wt. %, at least 90 wt. %, or at least 95 wt. %, based on the total weight of the PAES(P1), of a sulfone polymer selected from the group consisting of:
PPSU,
PSU,
PES,
sulfonated PSU (sPSU),
sulfonated PES (sPES),
sulfonated PPSU (sPPSU),
any polymer derived from a diol monomer selected from isosorbide and/or tetramethyl bisphenol F and a dihalo monomer selected from sulfonated dihalodiphenylsulfone and/or dihalodiphenylsulfone,
   any copolymer derived from at least two diols selected from biphenol, bisphenol A, bisphenol S, isosorbide, tetramethyl bisphenol F, and/or hydroquinone and a dihalo monomer selected from sulfonated dihalodiphenylsulfone and/or dihalodiphenylsulfone,
   a block polymer in the form A-B or A-B-A, comprising at least one block having one recurring unit selected from those of formulae (L), (L′), (N), (N′), (O), (O′), (Q), (Q′), and at least one block having one recurring unit selected from those of formulae (T), (T′), (U), (U′), (V), (V′), (W), (W′), (U*), (V*), (W*);
   a block copolymer in the form A-B or A-B-A, comprising at least one block having one recurring unit selected from those of formulae (L), (L′), (N), (N′), (O), (O′), (Q), (Q′), and at least one polyalkylene oxide or polyvinylpyrrolidone (PVP) block, such as a PEG block, PPG block or a PVP block; and
   any combination of two or more thereof,
      wherein the formulae (L), (L′), (N), (N′), (O), (O′), (Q), (Q′), (T), (T′), (U), (U′), (V), (V′), (W), (W′), (U*), (V*), (W*); are defined earlier.

As used herein, a polyethersulfone (PES) comprises at least 90 mol. %, at least 95 mol. %, or at least 98 mol. % of, or consists essentially of, recurring units (RPEs) of the formula (O), the mol. % being based on the total number of moles of recurring units in the PES polymer. PES can be prepared by known methods and is notably available as VERADEL® PES from Solvay Specialty Polymers USA, L.L.C.

As used herein, a polysulfone (PSU) comprises at least 90 mol. %, at least 95 mol. %, or at least 98 mol. % of, or consists essentially of, recurring units (R_{PSU}) of the formula (L), the mol. % being based on the total number of moles of recurring units in the PSU polymer. PSU can be prepared by known methods and is notably available as Udel® PSU from Solvay Specialty Polymers USA, L.L.C.

As used herein, a polyphenylsulfone (PPSU) comprises at least 90 mol. %, at least 95 mol. %, or at least 98 mol. % of, or consists essentially of, recurring units (R_{PPSU}) of the formula (Q), the mol. % being based on the total number of moles of recurring units in the PPSU polymer). PPSU can be prepared by known methods and is notably available as RADEL® PPSU from Solvay Specialty Polymers USA, L.L.C.

As used herein, a sulfonated polyethersulfone (sPES) comprises at least 60 mol. %, at least 70 mol. %, at least 80 mol. %, at least 90 mol. %, at least 95 mol. %, or at least 98 mol. % of, or consists essentially of, a combination of recurring units (R_{PES}) of the formula (O) and recurring units (R_{PES}) of the formula (O′), the mol. % being based on the total number of moles of recurring units in the sPES polymer, wherein each R in the formula (O′) is independently selected from the group consisting of alkali or alkaline earth metal sulfonate and alkyl sulfonate; and each i is independently an integer of 1 to 4.

As used herein, a sulfonated polysulfone (sPSU) comprises at least 60 mol. %, at least 70 mol. %, at least 80 mol. %, at least 90 mol. %, at least 95 mol. %, or at least 98 mol. % of, or consists essentially of, recurring units (R_{PSU}) of the formula (L) and recurring units (R_{sPSU}) of the formula (L′), the mol. % being based on the total number of moles of recurring units in the sPSU polymer, wherein each R in the formula (L′) is independently selected from the group consisting of alkali or alkaline earth metal sulfonate and alkyl sulfonate; and each i is independently an integer of 1 to 4.

As used herein, a sulfonated polyphenylsulfone (sPPSU) comprises at least 60 mol. %, at least 70 mol. %, at least 80 mol. %, at least 90 mol. %, at least 95 mol. %, or at least 98 mol. % of, or consists essentially of, recurring units (R_{PPSU}) of the formula (Q) and recurring units (R_{PPSU}) of the formula (Q′), the mol. % being based on the total number of moles of recurring units in the sPPSU polymer, wherein each R in the formula (Q′) is independently selected from the group consisting of alkali or alkaline earth metal sulfonate and alkyl sulfonate; and each i is independently an integer of 1 to 4.

When used, the block polymer in the form A-B or A-B-A in the PAES (P1) may comprise
at least one sulfone polymer block having at least one recurring unit selected from those of PPSU, sPPSU, PSU, sPSU, PES, sPES, and at least one block having recurring units made from tetramethyl bisphenol F and sulfonated or non-sulfonated dihalodiphenylsulfone or from a 1,4:3,6-dianhydrohexitol sugar diol (e.g., isosorbide) and sulfonated or non-sulfonated dihalodiphenylsulfone; or
at least one block polymer having recurring units selected from those of PPSU, sPPSU, PSU, sPSU, PES, sPES, and at least one polyalkylene oxide or polyvinylpyrrolidone (PVP) block, such as a PEG block, PPG block or PVP block.

As used herein, a polyvinylpyrrolidone (PVP) block or polymer may comprise at least 90 mol. %, at least 95 mol. %, or at least 98 mol. % of, or may consist essentially of, recurring units Rp of following formula:

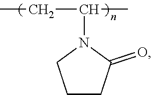

based on the total number of moles of recurring units in the PVP block or polymer,
in which n is an integer of at least 3, or at least 5, or at least 8, or at least 10, or at least 20, or at least 30, or at least 40, or at least 50, and at most 200, or at most 175, or at most 150, or at most 100.

As used herein, a “polyalkylene oxide” is understood to mean those polyalkylene oxides obtained by polymerisation of alkylene oxide such as ethylene oxide, 1,2-propylene oxide. The “polyalkylene oxide” may be generally represented by the following formula: —[(CHRₗ)_{y}O]_{z}—H in which R₁ is H or an alkyl; y may be 1 to 3; z may be from 2 to 500. Polyethylene glycol (PEG) and polypropylene glycol (PPG) are examples of polyalkylene oxides.

In yet more preferred embodiments in the process for producing a polyarylethersulfone (P2) using a recycled polymeric material comprising the polyarylethersulfone (P1) as a reactant, the PAES (P1) comprises at least 50 wt. %, at least 60 wt. %, at least 70 wt. %, at least 80 wt. %, at least 90 wt. %, or at least 95 wt. %, or consists of, a sulfone polymer selected from the group consisting of PPSU, PSU, PES, sPSU, sPES, sPPSU, and any combination thereof, the wt. % being based on the total weight of the PAES (P1).

In alternate embodiments in the process for producing a polyarylethersulfone (P2) using a recycled polymeric material comprising the polyarylethersulfone (P1) as a reactant, PAES (P1) may in some instances consist of a blend of PES/PPSU, of PES/PSU, of PSU/PPSU, of PES/PSU/PPSU, of PES/sPES, of PSU/sPSU, or of PPSU/sPPSU.

The PAES (P1) polymer may be produced by a variety of methods. The PAES (P1) is preferably derived by polycondensation from at least one aromatic diol monomer (AA′) and at least one aromatic dihalo monomer (BB′).

For example U.S. Pat. Nos. 4,108,837 and 4,175,175 describe the preparation of polyarylethers and in particular polyarylethersulfones. Several one-step and two-step processes are described in these patents, which patents are incorporated herein by reference in their entireties. In these processes, a double alkali metal salt of a dihydric phenol (aromatic diol AA′) is reacted with a dihalobenzenoid compound (aromatic dihalo BB′) in the presence of a polar aprotic solvent under substantially anhydrous conditions. In a two-step process, the aromatic diol AA′ is first converted, in situ, in the presence of the solvent to the alkali metal salt derivative by reaction with an alkali metal or an alkali metal compound. An alkali metal salt is produced as a byproduct of the polymerization.

For PAES (P1) manufacture, the preferred starting aromatic diol monomer (AA′) may be selected from the group consisting of 4,4′-biphenol, bisphenol A, bisphenol S (4,4′-dihydroxydiphenyl sulfone), 1,4:3,6-dianhydrohexitol sugar diols such as isosorbide, tetramethyl bisphenol F, hydroquinone, and any combination thereof.

For PAES (P1) manufacture, the preferred starting aromatic dihalo monomer (BB′) may be selected from the group consisting of 4,4′-dihalodiphenylsulfones and sulfonated derivatives thereof, preferably selected from 4,4′-difluorodiphenylsulfone (DFDPS), 4,4′-dichlorodiphenylsulphone (DCDPS), disulfonated DCDPS, and/or disulfonated DFDPS, and any combination thereof, more preferably selected from DCDPS and/or disulfonated DCDPS.

In some embodiments for the manufacture of a PAES (P1) copolymer, a first aromatic diol monomer (AA′)₁ may be selected from the group consisting of 4,4′-biphenol, bisphenol A, bisphenol S, and hydroquinone, and a second aromatic diol monomer (AA′)₂ may be selected from the group consisting of tetramethyl bisphenol F, 1,4:3,6-dianhydrohexitol sugar diols such as isosorbide, and any combination thereof.

The weight average molecular weight Mw of the PAES (P1) may be from 30,000 to 100,000 g/mol, for example from 35,000 to 90,000 g/mol or from 40,000 to 85,000 g/mol. The weight average molecular weight (Mw) of PAES (P1) can be determined by gel permeation chromatography (GPC) using methylene chloride as a mobile phase (2×5μ mixed D columns with guard column from Agilent Technologies; flow rate: 1.5 mL/min; injection volume: 20 μL of a 0.2 w/v % sample solution), calibrated with polystyrene standards.

### Polyarylethersulfone (P2)

The process of the present invention forms a polyarylethersulfone (P2).

The PAES (P2) may be a polymer comprising at least 50 mol %, based on the total number of moles of recurring units in PAES (P1), of at least one recurring unit selected from those of the formulae (L), (L′), (N), (N′), (O), (O′), (Q), (Q′), (T), (T′), (U), (U′), (V), (V′), (W), (W′), (U*), (V*), (W*), as provided earlier in relation to PAES (P1). The PAES (P2) may be a homopolymer having a recurring unit selected from those of the formulae (L), (L′), (N), (N′), (O), (O′), (Q), (Q′), (T), (T′), (U), (U′), (V), (V′), (W), (W′), (U*), (V*), (W*) or may be a copolymer comprising two or more recurring units selected from those of the formulae (L), (L′), (N), (N′), (O), (O′), (Q), (Q′), (T), (T′), (U), (U′), (V), (V′), (W), (W′), (U*), (V*), (W*). In preferred embodiments, each R, in the recurring units selected from those of the formulae (L′), (N′), (O′), (Q′), (T′), (U′), (V′) and (W′), may be independently selected from the group consisting of alkali or alkaline earth metal sulfonates and alkyl sulfonates, and each i is independently selected from integers from 1 to 4.

In particular, the PAES (P2) may be a copolymer comprising at least 60 mol. %, based on the total number of moles of recurring units of PAES (P2), or consisting essentially of,
the recurring units of formulae (L), (L′),
the recurring units of formulae (N), (N′),
the recurring units of formulae (O), (O′),
the recurring units of formulae (Q), (Q′),
the recurring units of formulae (T), (T′),
the recurring units of formulae (U), (U′),
the recurring units of formulae (V), (V′), or
the recurring units of formulae (W), (W′),
   in which each R, in recurring units of formulae (L′), (M′), (N′), (O′), (T′), (U′), (V′), and (W′), may be independently selected from the group consisting of alkali or alkaline earth metal sulfonates and alkyl sulfonates, and each i is independently an integer of from 1 to 4.

When the PAES (P1) is added as a reactant in (RM) comprises a recurring unit selected from those of the formulae (L), (L′), (N), (N′), (O), (O′), (Q), (Q′), (T), (T′), (U), (U′), (V), (V′), (W), (W′), the PAES (P2) also comprises the same recurring unit as in PAES (P1). However, the mol. % content of such recurring unit in PAES (P2), based on the total number of moles of recurring units in PAES (P2), may differ from the mol. % content of this recurring unit in PAES (P1). For example, when the PAES (P1) is PPSU consisting essentially of recurring units of formula (Q) and the at least one monomer (M) added to the reaction consists of a combination of biphenol and sulfonated DCDPS, the resulting PAES (P2) comprises not only the recurring unit of formula (Q′) but also the same recurring unit (Q) albeit its content in PAES (P2) would be less than 100 mol. % based on the total number of moles of recurring units in PAES (P2).

The PAES (P2) preferably comprises at least 50 wt. %, at least 60 wt. %, at least 70 wt. %, at least 80 wt. %, at least 90 wt. %, or at least 95 wt. %, based on the total weight of the PAES (P1), of a sulfone polymer selected from the group consisting of:
PPSU;
PSU;
PES;
sulfonated PSU (sPSU);
sulfonated PES (sPES);
sulfonated PPSU (sPPSU);
a copolymer derived from a diol selected from 4,4′-biphenol, bisphenol A, bisphenol S, or hydroquinone, and two dihalo monomers selected from disulfonated DCDPS+DCDPS or DFDPS+disulfonated DFDPS;
a homopolymer derived from a diol selected from isosorbide or tetramethyl bisphenol F and a dihalo monomer selected from disulfonated DCDPS, DCDPS, DFDPS, or disulfonated DFDPS; and
a copolymer derived from two diols selected from 4,4′-biphenol, bisphenol A, bisphenol S, isosorbide, tetramethyl bisphenol F, and hydroquinone and a dihalo monomer selected from disulfonated DCDPS and/or DCDPS.

The PAES (P2) more preferably comprises at least 50 wt. % of a sulfone polymer selected from the group consisting of PPSU, PSU, PES, sPSU, sPES, sPPSU, and any combination thereof, the wt. % being based on the total weight of the PAES (P2).

The PAES (P2) may have an M_{W(P2)} of at least 40 kDa, at least 50 kDa, or at least 55 kDa, and/or at most 150 kDa, at most 130 kDa, at most 110 kDa, at most 100 kDa, or at most 90 kDa, said M_{W(p2)} being measured via GPC method using methylene chloride as mobile phase and calibrated with polystyrene standards. Preferred ranges for M_{W(p2)} may be from 50 kDa to 100 kDa or from 55 kDa to 90 kDa.

In some embodiments, the PAES (P2) has an M_{W(p2)} which is within +/−35% of the M_{W(P1)} of the PAES (P1); and/or the PAES (P2) has a PDI_{P2} value which is within +/−35% of the PDI_{P1} value of the PAES (P1).

In particular, the weight average molecular weight (Mw) and number average molecular weight (Mₙ) of PAES (P2) can be determined by gel permeation chromatography (GPC) using methylene chloride as a mobile phase (2×5μ mixed D columns with guard column from Agilent Technologies; flow rate: 1.5 mL/min; injection volume: 20 μL of a 0.2 w/v % sample solution), calibrated with polystyrene standards.

The polydispersity index (PDI) is hereby expressed as the ratio of weight average molecular weight (M_{w}) to the number average molecular weight (Mₙ).

### Recycled Polymeric Material

The recycled polymeric material to be added to the reaction medium (RM) in the process of the present invention may be considered a waste, such as end-of-life products or articles, industrial scraps, and/or unsalable (e.g., off-specification, surplus) products or articles.

The polymeric material preferably comprises at least one recycled material selected from the group consisting of post-consumer polymeric articles, post-industrial polymeric articles or parts thereof, off-specification polyarylethersulfone products; and any combination thereof.

The polymeric material may comprise, or consist of, at least one recycled polymeric article selected from the group consisting of membranes, automotive components, electronic components, consumer product components such as plastic bottles (e.g., baby bottles), composites, battery components, any parts or scraps thereof, and any combination thereof.

The recycled polymeric material may comprise at least 50% by weight (wt. %), based on the total weight of the polymeric material, of the PAES (P1). The polymeric material preferably comprises at least 55% wt. %, at least 60% wt. %, at least 65% wt. %, at least 70% wt. %, at least 75% wt. %, at least 80% wt. %, at least 85% wt. %, at least 90% wt. %, at least 95% wt. % or at least 99% wt. %, based on the total weight of the polymeric material, of the PAES (P1).

The recycled polymeric material may consist essentially of the PAES (P1).

In alternate embodiments, the recycled polymeric material comprises the PAES (P1) and at least one additional component such as other non-PAES polymers, fillers, and/or additives.

Optional other polymer (P3) in polymeric material

The recycled polymeric material may further comprise another polymer (P3) which is different than the PAES (P1). The other polymer (P3) is preferably not a PAES, also referred to as a “non-PAES polymer”.

The other polymer (P3) in the recycled polymeric material preferably may be a pore-forming polymer such as polyvinylpyrrolidone (PVP), polyalkylene oxide, or polyalkylene glycols such as polyethylene glycol (PEG), or any combination thereof.

In instances when the recycled polymeric material further comprises another polymer (P3), the polymeric material may include:
a blend of the PAES (P1) and the other polymer (P3),
a coating or layer of one of the polymers (P1) and (P3) on top of at least a portion of a solid surface made from the other polymer, and/or
a block copolymer comprising at least one block of the PAES (P1) and at least another block of the other polymer (P3).

For example, the recycled polymeric material may comprise a blend of a PAES (P1) and, as a polymer (P3) a pore-forming polymer such as polyvinylpyrrolidone (PVP), a polyalkylene oxide or polyalkylene glycol (e.g., PEG, PPG) with a molecular weight of at least 200, preferably from 200 to 900, or any combination thereof.

In another example, the recycled polymeric material may comprise, as a polymer (P3), a block copolymer in the form A-B or A-B-A, wherein the blocks A, and B represent at least one PAES (P1) block and at least one polyalkylene oxide block, such as a PES:PEG, PPSU:PEG or PSU:PEG block copolymer.

In other embodiments, the other polymer (P3) in the recycled polymeric material may be a polycarbonate (PC).

The recycled polymeric material preferably comprises at most 25 wt. %, at most 20 wt. %, at most 15 wt. %, at most 10 wt. %, or at most 5 wt. %, based on the total weight of the recycled polymeric material, of the other polymer(s) (P3).

### Optional Solid Filler in Polymeric Material

The recycled polymeric material may further comprise a solid filler. The filler is preferably non-polymeric. The filler may be a reinforcing filler. Indeed when it is desired to form a polymeric molded article with reduced weight but a high mechanical strength, the polymeric material may be reinforced by fillers.

In such instances, the recycled polymeric material preferably comprises at most 60 wt. %, at most 55 wt. %, at most 50 wt. %, at most 45 wt. %, at most 40 wt. %, at most 35 wt. %, or at most 30 wt. % of the filler, and/or at least 2 wt. %, at least 4 wt. %, at least 6 wt. %, at least 8 wt. %, or at least 10 wt. %, of the filler, said wt. % being based on the total weight of the recycled polymeric material.

The filler may be in the form of particulate fillers, non-fibrous fillers, and fibrous fillers. A particulate reinforcing filler may be selected from mineral fillers (such as talc, mica, kaolin, calcium carbonate, calcium silicate, and magnesium carbonate) or glass balls (e.g., hollow glass microspheres). A fibrous reinforcing filler is considered herein to be a tri-dimensional material having length, width, and thickness, wherein the average length is significantly larger than both the width and thickness. Generally, such a fibrous material has an aspect ratio, defined as the ratio between the average length and the largest of the average width and average thickness of at least 5, at least 10, at least 20, or at least 50. A fibrous reinforcing filler may be selected from glass fibers, carbon fibers, aramid fibers, aluminum fibers, titanium fibers, magnesium fibers, boron carbide fibers, rock wool fibers, and/or steel fibers. Aramid fibers would be considered a polymeric filler. A “non-fibrous” filler is considered herein to have a tri-dimensional structure having a length, width, and thickness, wherein both length and width are significantly larger than its thickness. A non-fibrous reinforcing filler may contain glass or carbon.

In preferred embodiments, the recycled polymeric material may further comprise a non-polymeric filler selected from mineral fillers, carbon fibers, and/or glass fibers.

### Optional Additive(s) in Polymeric Material

The recycled polymeric material may further comprise one or more additional additives selected from the group consisting of ultraviolet light stabilizers, heat stabilizers, acid scavengers (i.e. zinc oxide, magnesium oxide), antioxidants, pigments, processing aids, lubricants, flame retardants, and/or conductivity additive (i.e. carbon black, carbon nanotubes and carbon nanofibrils).

In such instances, the recycled polymeric material preferably comprises at most 15 wt. %, at most 10 wt. %, at most 7.5 wt. %, or at most 5 wt. %, of the one or more additional additives, and/or at least 0.01 wt. %, at least 0.05 wt. %, at least 0.08 wt. %, at least 0.1 wt. %, or at least 1 wt. %, of the one or more additional additives, said wt. % being based on the total weight of the recycled polymeric material.

### Monomer (M) in the Reaction Medium

At least one monomer (M) selected from at least one aromatic diol monomer (AA) and/or at least one aromatic dihalo monomer (BB) is added to the reactor vessel before the polycondensation reaction is started.

Preferably at least one monomer (M) comprises at least one aromatic diol monomer (AA). At least one monomer (M) preferably comprises, based on the total number of moles of the monomer (M), at least 50 mol. %, at least 60 mol. %, at least 70 mol. %, at least 80 mol. %, at least 90 mol. %, at least 95 mol. %, or at least 99 mol. %, of the at least one aromatic diol monomer (AA).

When the PAES (P1) recycle ratio is 100 wt. %, at least one monomer (M) preferably consists essentially of at least one aromatic diol monomer (AA).

Among the diol monomers (AA) suitable for being used in the process of the present invention, mention may be notably made of the following compounds:

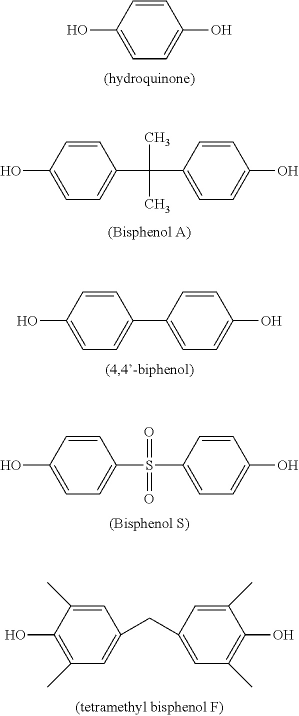 [SMILES: Oc1ccc(O)cc1 ; CC(C)(c1ccc(O)cc1)c1ccc(O)cc1 ; Oc1ccc(-c2ccc(O)cc2)cc1 ; O=S(=O)(c1ccc(O)cc1)c1ccc(O)cc1 ; Cc1cc(Cc2cc(C)c(O)c(C)c2)cc(C)c1O]

and/or the 3 isomers of the 1,4:3,6-dianhydrohexitol sugar diols, namely isosorbide (1), isomannide (2), and isoidide (3):

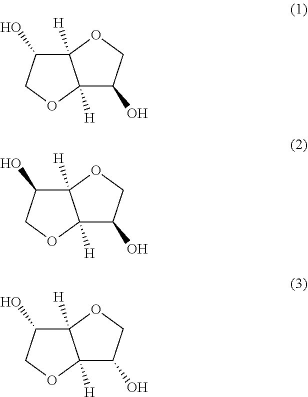 [SMILES: O[C@@H]1CO[C@H]2[C@@H]1OC[C@@H]2O ; O[C@@H]1CO[C@H]2[C@@H]1OC[C@H]2O ; O[C@H]1CO[C@H]2[C@@H]1OC[C@@H]2O]

The aromatic diol monomer (AA) may be selected from the group consisting of isosorbide (1), isomannide (2), and isoidide (3), and any combination thereof, or may be selected from the group consisting of 4,4′-biphenol, bisphenol A, bisphenol S, hydroquinone, tetramethyl bisphenol F, and any combination thereof.

The aromatic diol monomer (AA) is preferably selected from the group consisting of 4,4′-biphenol, bisphenol A, bisphenol S, isosorbide (1), tetramethyl bisphenol F, hydroquinone, and any combination thereof, more preferably selected from the group consisting of 4,4′-biphenol, bisphenol A, bisphenol S, tetramethyl bisphenol F, and any combination thereof.

When the added PAES (P1) is a PSU and the intended PAES (P2) is a PSU homopolymer or copolymer, then the selected aromatic diol monomer (AA) most preferably includes bisphenol A.

When the added PAES (P1) is a PPSU and the intended PAES (P2) is a PPSU homopolymer or copolymer, then the aromatic diol monomer (AA) most preferably includes 4,4′-biphenol.

When the added PAES (P1) is a PES and the intended PAES (P2) is a PES homopolymer or copolymer, then the aromatic diol monomer (AA) most preferably includes bisphenol S.

When an aromatic dihalo monomer (BB) is added to the reactor vessel, the aromatic dihalo monomer (BB) may be selected from the group consisting of 4,4′-difluorodiphenylsulfone (DFDPS), 4,4′-dichlorodiphenylsulfone (DCDPS), disulfonated derivatives thereof, and any combination thereof. More preferably, the aromatic dihalo monomer (BB) may be selected from the group consisting of DCDPS, disulfonated DCDPS, and any combination thereof.

### Alkali Salt-Forming Agent (A) in the Reaction Medium

The alkali salt-forming agent (A) may be at least one base selected from the group consisting of potassium carbonate (K₂CO₃), sodium carbonate (Na₂CO₃), cesium carbonate (Cs₂CO₃), sodium hydroxide (NaOH), potassium hydroxide (KOH), potassium tert-butoxide, and sodium tert-butoxide.

The alkali salt-forming agent (A) is preferably at least one base selected from the group consisting of potassium carbonate (K₂CO₃), sodium carbonate (Na₂CO₃), sodium hydroxide (NaOH), and potassium hydroxide (KOH), more preferably selected from the group consisting of potassium carbonate (K₂CO₃), sodium carbonate (Na₂CO₃), and sodium hydroxide (NaOH).

The base acts to deprotonate aromatic diol monomers to form an alkali salt of the diol.

### Polar Aprotic Solvent (S)

The condensation to prepare the PAES (P2) is carried out in a reaction medium (RM) comprising at least one polar aprotic solvent (S). The polar aprotic solvent (S) is preferably selected such that the PAES (P1) in the recycled polymeric material is soluble in this solvent.

The polar aprotic solvent (S) may be selected from the group consisting of 1,3-dimethyl-2-imidazolidinone (DMI), dimethylsulfoxide (DMSO), dimethylsulfone (DMSO2), diphenylsulfone, diethylsulfoxide, diethylsulfone, diisopropylsulfone, tetrahydrothiophene-1, 1-dioxide (commonly called tetramethylene sulfone or sulfolane), N-alkyl-2-pyrrolidone like N-Methyl-2-pyrrolidone (NMP), N-butylpyrrolidinone (NBP), N-ethylpyrrolidone (NEP), N,N′-dimethylacetamide (DMAc), N,N′-dimethylpropyleneurea (DMPU), dimethylformamide (DMF), tetrahydrothiophene-1-monoxide, and any combination thereof.

The polar aprotic solvent (S) is preferably selected from the group consisting of NMP, NBP, NEP, DMF, DMAc, DMI, DMSO, diphenylsulfone, and sulfolane.

The polar aprotic solvent (S) is more preferably selected from the group consisting of sulfolane, DMSO, DMAc, DMI, NMP, diphenylsulfone, and any combination thereof; most preferably selected from the group consisting of sulfolane, DMSO, DMAc, NMP, diphenylsulfone, and any combination thereof.

### Optional Co-Solvent

The condensation reaction to prepare the PAES (P2) may be carried out in a mixture of the polar aprotic solvent (S) and a co-solvent which forms an azeotrope with water. The co-solvent which forms an azeotrope with water includes aromatic hydrocarbons such as benzene, toluene, xylene, ethylbenzene, monochlorobenzene, and the like. The co-solvent is preferably toluene or monochlorobenzene (MCB). The azeotrope forming co-solvent and the polar aprotic solvent (S) are used typically in a weight ratio of from about 1:10 to about 1:1, preferably from about 1:5 to about 1:1. Water is continuously removed from the reaction medium as an azeotrope with the azeotrope forming co-solvent so that substantially anhydrous conditions are maintained during the polymerization. The azeotrope-forming co-solvent, for example, chlorobenzene or toluene, is removed from the reaction medium, typically by distillation, after the water formed in the reaction is removed leaving the formed PAES (P2) dissolved in the polar aprotic solvent (S).

### Addition Steps in the Process

The various ingredients (that is to say, the recycled polymeric material, the at least one monomer (M), the alkali salt-forming agent (A) and the polar aprotic solvent (S), optional components such as polar aprotic solvent (S₀) and/or co-solvent) of the reaction medium (RM) may be added simultaneously or sequentially.

In some embodiments when the at least one monomer (M) includes at least one aromatic diol monomer (AA), the diol (AA) and the alkali salt-forming agent (A) may be added together to the reactor vessel in the form of an alkali salt (AAA) of the diol (AA). In such case, the aromatic diol monomer (AA) is mixed ex-situ in a vessel separate from the reactor vessel (e.g., a feed tank) with the alkali salt-forming agent (A) in a polar aprotic solvent (S₀). It may be necessary to heat the mixture of the aromatic diol (AA)+alkali salt-forming agent (A)+solvent (S₀) in order to facilitate its reaction with the alkali salt-forming agent (A) (prior to polycondensation) to form phenoxides and/or bisphenoxides and to generate an alkali salt of the diol, hereinafter referred to as (AAA). The temperature of the mixture of diol (AA)+agent (A)+solvent (S₀) may be from at least ambient temperature but should not exceed the boiling point of the solvent (S₀), preferably from 25° C. to 300° C. The alkali salt (AAA) of the diol (AA) is then added to the reactor vessel. After (bis)phenoxide formation, the alkali salt (AAA) of the diol (AA) in the solvent (S₀) may be dehydrated (to remove water formed during (bis)phenoxide formation) before being added to the reactor vessel. Any of the solvents described herein for the polar aprotic solvent (S) is equally suitable for the solvent (S₀) used for the ex situ phenoxide reaction. The polar aprotic solvent (S₀) is preferably selected from the group consisting of sulfolane, DMSO, DMAc, DMI, DMF, NMP, and combinations thereof. The polar aprotic solvent (S₀) is preferably the same polar aprotic solvent (S) used in the reactor medium, but not necessarily. When the polar aprotic solvent (S) and (S₀) are the same, they are preferably selected from sulfolane, DMSO, DMI, DMAc, NMP, or any combinations thereof.

In some cases, the recycled polymeric material comprising the PAES (P1) may be added to the reactor vessel in solid form, such as pellets, fibers, powder, flakes, pieces of shredded or ground articles, coagulated solids (e.g., coagulated polymer beads, particles, or prills), any other solid 3-D objects, or any mixture thereof. The pellets for example may be in any shape, such as cylindrical, spherical, or ovoid. In particular, when the recycled polymeric material may comprise a post-industrial waste from a polyarylethersulfone manufacturing plant, such waste may be obtained after a coagulation step (in coagulated form) and subsequently not dried before being recycled and used as a reactant in the current process. The shape and size of the recycled polymeric material are not critical so long as the PAES (P1) in the recycled polymeric material can dissolve, at least in part, preferably completely, in the polar aprotic solvent.

In some embodiments, the recycled polymeric material comprising the PAES (P1) may be added directly to the reactor vessel in solid form, and at least some of the PAES (P1) is “pre-dissolved” with some or all of the polar aprotic solvent (S) before adding the other components (A) and (M) of the reaction medium (RM). It may be necessary to heat during pre-dissolution in order to facilitate the dissolution of PAES (P1). The dissolution may be favored at a temperature of at least ambient temperature, but should not exceed the boiling point of the solvent (S), preferably from 50° C. to 150° C. or from 70° C. to 130° C.

In other embodiments, the monomer(s) (M) and the recycled polymeric material comprising the PAES (P1) may be added directly to the reactor vessel in solid form, and the monomer(s) (M) and at least part of the PAES (P1) are “pre-dissolved” with the polar aprotic solvent (S) before adding the component (A) to the reactor vessel. It may be necessary to heat during pre-dissolution in order to facilitate the dissolution of monomer(s) (M) and PAES (P1). The dissolution may be favored at a temperature of at least ambient temperature but should not exceed the boiling point of the solvent (S), preferably from 50° C. to 150° C. or from 70° C. to 130° C.

In alternate embodiments, the recycled polymeric material comprising the PAES (P1) may be added to the reactor vessel in form of a solution or slurry in which at least some of the PAES (P1) is “pre-dissolved” ex-situ, that is to say, not in the reactor vessel, before being added to the reactor vessel. In such instances, the recycled polymeric material may be mixed with a polar aprotic solvent (S₀). It may be necessary to heat the mixture of the recycled polymeric material+ solvent (S₀) in order to facilitate the dissolution of PAES (P1) into the solvent (S₀). The dissolution may be favored at a temperature of at least ambient temperature but should not exceed the boiling point of the solvent (S₀), preferably from 50° C. to 150° C. or from 70° C. to 130° C. Such pre-dissolution preferably takes place in a vessel separate from the reactor vessel (e.g., a feed tank). In instances when the resulting pre-dissolved material is in the form of a slurry containing solids such as insoluble fillers originating from the recycled polymeric material, the solids may be removed (e.g., the slurry is filtered) to recover a PAES (P1) solution. The PAES (P1) solution is then added to the reactor vessel. The polar aprotic solvent (S₀) into which the PAES (P1) may be pre-dissolved is preferably the same polar aprotic solvent (S) used in the reactor medium, but not necessarily. Such polar aprotic solvent (S₀) is particularly selected for its ability to completely dissolve the PAES (P1) and optionally the monomer(s) (M) when it is mixed ex-situ with PAES (P1). Any of the solvents described herein for the polar aprotic solvent (S) is equally suitable for pre-dissolving the PAES (P1) and optionally the monomer(s) (M) before addition to the reactor vessel. The polar aprotic solvent (S₀) is preferably selected from the group consisting of sulfolane, DMSO, DMAc, DMI, DMF, NMP, and combinations thereof. When the polar aprotic solvent (S) and (S₀) are the same, they are preferably selected from sulfolane, DMSO, DMAc, NMP, or combinations thereof.

In particular embodiments, the various addition steps for preparing the reaction medium (RM) may be carried out as follows:
the recycled polymeric material comprising PAES (P1) is loaded into the reactor vessel with the solvent (S) to dissolve the PAES (P1) into the solvent (S), preferably by heating at a temperature of from ambient temperature to less than the boiling point of the solvent (S), preferably from 50° C. to 150° C. or from 70° C. to 130° C.; and
then the at least monomer (M) and the alkali salt-forming agent (A) are added, simultaneously or in succession, to the reactor vessel after the PAES (P1) is dissolved. In some instances when the at least monomer (M) includes an aromatic diol (AA), the diol (AA) and the alkali salt-forming agent (A) may be added ‘as is’, or they may be mixed and reacted ex-situ in a separate vessel (e.g., a feed tank) to form (bis)phenoxides and generate an alkali salt (AAA) of the diol (AA).

The resulting alkali salt (AAA) of the diol (AA) is then added to the reactor vessel. After (bis)phenoxide formation, the alkali salt (AAA) of the diol (AA) in the solvent (S₀) may be dehydrated (to remove water formed during (bis)phenoxide formation) before being added to the reactor vessel.

In alternate embodiments, the various addition steps for preparing the reaction medium (RM) may be carried out as follows:
the recycled polymeric material comprising PAES (P1) is pre-dissolved ex-situ (i.e., in a feed tank separate from the reactor vessel) with the solvent (S) [or solvent (S₀) if different than solvent (S)] to dissolve the PAES (P1), preferably by heating at a temperature of from ambient temperature to less than the boiling point of the solvent (S), preferably from 50° C. to 150° C. or from 70° C. to 130° C., and optionally after dissolution, filtered to remove solids; and
then the pre-dissolved PAES (P1), the at least monomer (M), the alkali salt-forming agent (A), and optionally the solvent (S) [if solvent (S₀) was used for the PAES (P1) pre-dissolution and/or for phenoxides formation] are added, simultaneously or successively, to the reactor vessel. Similarly as explained earlier, in some instances when the at least monomer (M) includes an aromatic diol (AA), the diol (AA) and the alkali salt-forming agent (A) may be reacted (to form (bis)phenoxides) before polycondensation and added to the reactor vessel in the form of an alkali salt (AAA) of the diol (AA). After (bis)phenoxide formation, the alkali salt (AAA) of the diol (AA) in the solvent (S₀) may be dehydrated before being added to the reactor vessel.

In yet alternate embodiments, the various addition steps for preparing the reaction medium (RM) may be carried out as follows:
the at least monomer (M) and the recycled polymeric material comprising PAES (P1) are loaded into the reactor vessel with the solvent (S) to dissolve the monomer(s) (M) and the PAES (P1) into the solvent (S), preferably by heating at a temperature of from ambient temperature to less than the boiling point of the solvent (S), preferably from 50° C. to 150° C. or from 70° C. to 130° C.; and
then the alkali salt-forming agent (A) is added to the reactor vessel after the dissolution of monomer(s) (M) and PAES (P1).

### Polycondensation Reaction Step

Without wishing to be limited by theory, it is believed that the trans-etherification chemistry effects the scrambling of the ether bonds of the recurring units of the recycled polymer PAES (P1) and the polymeric chains being formed from the monomers/oligomers thereby getting them incorporated into the final chains of the resulting polymer PAES (P2) being formed by the process of the present invention.

In particular, when the recycle ratio is 100 wt. %, the trans-etherification scrambles the ether bonds of the recurring units of the recycled PAES (P1), so that the resulting polymer PAES (P2) is generally identical in chemical structure (same recurring units) and very similar in properties to a virgin polymer that would be made from only monomers, and as a consequence, the use of polymer PAES (P2) should be without any limitations.

Similarly, when monomers which are added to the reaction medium (RM) and which favor the formation of new polymer chains correspond to the same monomers from which the recycled PAES (P1) is derived, the resulting polymer PAES (P2) would also be identical in chemical structure (same recurring units) and with very similar properties compared to a virgin polymer directly obtained from these added monomers, for example, the process may include using a recycled PES waste material and adding bisphenol S and DCDPS to the reactor vessel to form a new PES polymer (P2) having PES recurring units having the formula (O).

On the other end, when monomers added to the reaction medium (RM) favor the formation of new polymer chains of a different type of sulfone polymer, the resulting polymer PAES (P2) would differ in chemical structure compared to the recycled PAES (P1), in that PAES (P2) will contain same recurring units as PAES (P1) but also different recurring units resulting from the condensation of the added monomers. In such an instance, the resulting PAES (P2) will likely differ in some properties when compared to the recycled PAES (P1) and to a virgin polymer that would be obtained, without recycled (P1), with the monomers added to the reaction medium (RM). For example, the process may include using a recycled PES waste material and adding biphenol and DCDPS to the reactor vessel to form a new copolymer having not only PES recurring units having the formula (O) but also having some PPSU recurring units having the formula (Q).

The main advantage of the process according to the present invention is that it includes a one-pot synthesis (in the same reactor vessel) from a recycled polymeric material containing the PAES (P1) used as a reactant. The polymeric material containing the PAES (P1) is added to the reaction medium, preferably before polycondensation starts.

Thus, the reaction medium (RM) in the reactor vessel comprises the polymeric recycled material containing the PAES (P1), at least one monomer (M), the alkali salt-forming agent (A), and the polar aprotic solvent (S), before the polycondensation starts.

The reaction medium (RM) may further contain a polar aprotic solvent (S₀) used to pre-dissolve the PAES (P1) and/or an azeotrope forming co-solvent, as previously described.

When the at least one monomer (M) comprises at least one aromatic diol monomer (AA), the reaction medium (RM) comprises a molar ratio of the alkali salt-forming agent (A) to the aromatic diol monomer (AA) of
at least 0.95:1, at least 0.98:1, at least 0.99, at least 0.995, or at least 1:1; and/or
at most 2.5:1, at most 2.2:1, at most 2:1, at most 1.8:1, at most 1.6:1, at most 1.4:1; at most 1.35:1. or at most 1.3:1.

When the at least one monomer (M) comprises at least one aromatic diol monomer (AA) and at least one aromatic dihalo monomer (BB), the reaction medium (RM) comprises a molar ratio of the aromatic dihalo monomer(s) (BB)/the aromatic diol monomer(s) (AA) of at least 0.9:1, at least 0.92:1, at least 0.95:1, at least 0.98:1, at least 0.99, at least 0.995, or at least 1:1; and/or at most 1.1:1, at most 1.08:1, at most 1.07:1, at most 1.06:1; at most 1.05:1. or at most 1.04:1. Preferred molar ratios of aromatic dihalo monomer(s) (BB)/aromatic diol monomer(s) (AA) are from 0.95 to 1.05, or from 0.98 to 1.02, or from 0.99 to 1.01.

The reaction medium (RM) preferably comprises from 5 to 40 wt. %, from 10 to 35 wt. %, from 5 to 40 wt. %, from 15 to 35 wt. %, from 20 to 35 wt. %, or from 20 to 30 wt. %, based on the total weight of the reaction medium, of PAES polymers ((P1) and (P2), during the reaction time.

The reaction time may be from 2 to 20 hours, preferably from 3 to 12 hours, more preferably from 3 to 10 hours, yet more preferably from 3.5 to 8 hours, most preferably from 3.5 to 6 hours.

The reaction temperature to form the PAES (P2) is at least 150° C. The reaction temperature is preferably at least 160° C., at least 165° C., at least 170° C., at least 175° C., at least 180° C., at least 185° C., at least 190° C., at least 195° C., or at least 200° C.; and/or at most 350° C., at most 300° C., at most 295° C., at most 290° C., at most 285° C., at most 280° C., at most 275° C., at most 270° C., at most 265° C., or at most 260° C. Preferred ranges for may be from about 150° C. to about 350° C., from about 160° C. to about 350° C., from about 160° C. to about 295° C., from about 160° C. to about 290° C., from about 165° C. to about 285° C. or from about 170° C. to about 280° C.

### Recycle Ratio

The recycled polymeric material comprising the PAES (P1) may be added to the reactor medium to achieve a PAES (P1) recycle ratio of from 100 wt. % to 1 wt. %, preferably from 100 wt. % to 5 wt. %. Such recycle ratio is the ratio of the weight of the added PAES (P1) over the combined weight of the added PAES (P1) and the maximum weight of additional polymer which would be theoretically produced based on the equimolar stoichiometry of polycondensation of monomers (AA) and (BB) when both diol monomer (AA) and dihalo monomer (BB) are added to the reactor medium.

For example, when 1.015 moles of biphenol and 1 mole of DCDPS are added to the reaction medium since the polycondensation requires equimolar amounts of biphenol (diol AA) and DCDPS (dihalo BB) to yield a PPSU recurring unit of formula (Q):

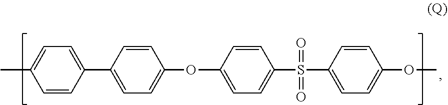

a maximum of 1 mole of polycondensed PPSU from these monomers (AA) and (BB) can be formed. Since the PPSU recurring unit of formula (Q) has a molecular weight of 400 g/mol, a maximum of 400 g of PPSU polymer can be produced from 1.015 mol of biphenol (diol AA) and 1 mol of DCDPS (dihalo BB). In such instance, when 40 g of recycled PPSU as PAES (P1) are added to the reaction medium, the PPSU recycle ratio would be 40 g/(40 g+400 g)=9 wt. %. On the other end, when 400 g of recycled PPSU as PAES (P1) are added to the reaction medium containing 0.1015 moles of biphenol and 0.1 moles of DCDPS (to generate a maximum of 40 g PPSU), the PPSU recycle ratio would be 400 g/(400 g+40 g)=90.9 wt. %. When only recycled PPSU and biphenol (without DCDPS) are added to the reaction medium, then the PPSU recycle ratio is 100 wt. %.

The same type of calculation can be used:
for PES generated from Bisphenol S and DCDPS (as monomers AA and BB respectively), with a PES recurring unit molecular weight of 464 g/mol or
for PSU generated from Bisphenol A and DCDPS (as monomers AA and BB respectively), with a PSU recurring unit molecular weight of 442 g/mol.

In another way, one can calculate the number of moles of monomers (AA) and (BB) to add once the recycle ratio is selected. For example in the case when “m₁” g of PAES (P1) is added to the medium (RM) and a given recycle ratio “z” (being from 0.01 to 1 used for 1 to 100 wt. %) is desired, then the amount “y” of polymer that can be produced from monomers AA and BB is calculated as follows: y=(m₁−z m₁)/z. When m₁=400 g of PES is added and a recycling ratio of 40 wt. % (z=0.4) is desired, then 600 g of PES can be produced or 600/464=1.293 moles of PES to be made. Then 1.293 moles of DCDPS are used, whereas 1.293 moles or more of bisphenol S may be used.

In instances when no aromatic dihalo (BB) or no aromatic diol (AA) is added to the reaction medium, there would be no possibility to create new polymer chains from the at least the monomer (M) since one of the monomers (AA) and (BB) is absent from the reaction medium. The recycle ratio of the PAES (P1) in the process is then 100 wt. %.

### Separation Step in the Process to Recover PAES (P2)

At the end of the reaction, the PAES (P2) is separated from the other components of the reaction medium. The separated PAES (P2) may be in the form of a PAES (P2) solution or in solid form (such as coagulated or dried).

The non-polymeric components, for example, sodium chloride or potassium chloride or excess base, and non-polymeric fillers originating from the starting recycled polymeric material, may be removed from the reaction medium, before or after separation of the PAES (P2), by suitable methods such as dissolving and filtering, screening or extracting.

The separated PAES (P2) may be first recovered in the form of a PAES (P2) solution. This step may include filtration of the reaction medium to remove solid components and recover a PAES (P2) solution. The PAES (P2) solution should contain PAES (P2) dissolved in the solvent (S) (used during condensation) and optionally the solvent (S₀).

The PAES (P2) is preferably recovered in solid form from the solvent (S) and optionally the solvent (S₀) (if used for pre-dissolution of the PAES (P1)). This step may include filtration of the reaction medium to remove solid components (such as alkali salts and/or insoluble originating from the recycled polymeric material) and recover a PAES (P2) solution. In some embodiments when a 100 wt. % recycle ratio is used, meaning the polymeric chains of the resulting PAES (P2) are grown from depolymerized PAES (P1), there should not be many alkali salts being formed during the reaction, a filtration step may be omitted in the process of the present invention.

To recover the PAES (P2) in solid form, the PAES (P2) solution may be subjected to precipitation of the PAES (P2) solution from the solvent(s), preferably by coagulation, or devolatilization of the solvent(s) from the PAES (P2) solution.

The coagulation is based on precipitation of the PAES (P2) with a non-solvent or poor solvent. This coagulation step is preferably carried out by forming droplets of the PAES (P2) solution into a precipitation bath which comprises the non-solvent or poor solvent to form polymeric beads of PAES (P2). The non-solvent may be selected from C1-C5 alcohol such as methanol, ethanol, n-propanol, isopropanol, butanol, ethyl acetate, methyl acetate, acetone, butanone, water, or any mixture thereof. Preferred non-solvent include ethanol, methanol, water, or any mixture thereof. The poor solvent may be a mixture of non-solvent and solvent (S) and/or (S₀). The non-solvent or poor solvent may comprise at least 50 wt. %, preferably at least 60 wt. %, of water and/or C1-C5 alcohol such as methanol, or ethanol.

The recovered solid PAES (P2) can be subjected to one or more washes with a washing liquid to further remove salts or other ingredients that remain in the polymer solids. The washing liquid is preferably water and/or C1-C5 alcohol (e.g., methanol, ethanol, n-propanol, isopropanol). The washing liquid (e.g., water) is preferably at a temperature of at least 50° C., or at least 60° C., or at least 65° C. The washing liquid should be at a temperature not exceeding its boiling point. The washing liquid is preferably at a temperature of at most 90° C., or at most 85° C., or at most 80° C., or at most 75° C. The washing liquid is more preferably water at a temperature of from 60° C. to 80° C., or from 65° C. to 75° C. There may be two or more washes, using different washing liquids, such as first one or more washes with water and subsequently one or more washes with methanol.

The solid PAES (P2) may be dried at a temperature generally from about 50° C. to 120° C., preferably from about 80° C. to 120° C., more preferably at about 90-120° C., yet more preferably at about 90-110° C., preferably under vacuum.

The dried PAES (P2) can be used for preparing an article, such as, but not limited to, a fiber, a sheet, a film, or a membrane.

### Optional Steps in the Process

The process according to the present invention may further comprise at least one of the following steps, between the reaction (condensation) step and the separation step:
i. cooling: decreasing the temperature of the reaction medium;
ii. quenching: adding a solvent (S_{q}), which may be the same or different than the polar aprotic solvent (S), to quench the reaction medium, generally to stop the reaction and dilute the reaction medium to reduce its viscosity; and/or
iii. end-capping: adding an end-capping agent to convert hydroxyl end groups of the formed PAES (P2) to less reactive end groups.

In some embodiments of the process according to the present invention, only one optional step may be carried out.

Alternatively, at least two optional steps are carried out.

Step (i): Cooling may be affected by stopping the heating of the reaction medium. Cooling may be effected by adding, directly into the reaction medium, a further amount of the polar aprotic solvent (S) or another solvent which is at a temperature of at least 50° C. less, at least 60° C. less, or at least 70° C. less, than the reaction medium temperature. The solvent added to the reaction medium for cooling is preferably at ambient temperature. The solvent added for cooling is preferably selected from the group consisting of sulfolane, DMSO, DMAc, DMI, NMP, MCB, and any combination thereof. Alternatively, cooling may be affected by passing a cooling fluid (without being mixed with the reaction medium (RM)) inside cooling tubes or using a cooling jacket for the reactor vessel.

Step (ii): Quenching may be carried out at the end of the reaction to decrease the polymer content of the reaction medium to a value of 20 wt. % or less based on the total weight of the quenched reaction medium. The solvent (S_{q}) added for quenching is preferably the same as the polar aprotic solvent (S) used during the reaction, but not necessarily. The solvent (S_{q}) is preferably selected from the group consisting of sulfolane, DMSO, DMAc, DMI, NMP, MCB, and any combination thereof. After quenching, the polymer content of the quenched reaction medium is preferably from 5 to 20 wt. %, more preferably from 10 to 15 wt. %, based on the total weight of the quenched reaction medium.

The cooling and quenching steps (i) and (ii) may be carried out simultaneously by using a solvent (S_{q}) having a cooler temperature than the reaction temperature of the reaction medium at end of the reaction.

Step (iii): The end-capping (also called termination) preferably converts reactive hydroxyl end groups of the formed PAES (P2) to less reactive end groups. The end-capping agent is preferably methyl chloride (“MeCl”). The methyl chloride gas may be passed through the reaction medium. The end-capping step (iii) may take place before or after the cooling of the reaction medium. As such the end-capping step (iii) may be carried out at the end of the polycondensation reaction, either at reaction temperature or at a lower temperature than the reaction temperature. If one desires to obtain a final PAES (P2) product with reactive (—OH) end groups, the end-capping step (iii) is preferably omitted in the process of the present invention.

### Use of the PAES (P2)

Another aspect of the present invention provides the use of the PAES (P2) for preparing an article (or a part thereof) as described herein.

### Method for Preparing an Article

Another aspect of the present invention provides a method for preparing or making an article (or a part thereof) comprising the PAES (P2). The method for making the article may comprise using the PAES (P2) in forming the article or part thereof.

The article may be formed from a solution comprising the PAES (P2).

When the article is a membrane or a part thereof, the method may include a phase inversion occurring in a liquid phase (e.g., precipitation bath) to form the membrane or part thereof from a PAES (P2) containing solution.

The method may include a solution spinning technique.

### Article Comprising the PAES (P2)

Another aspect of the present invention provides an article (preferably a shaped article) comprising the PAES (P2) according to the present invention.

The article may be an injection molded article, an extruded article, a pultruded article, or a solution-processed article (e.g., solution casted).

An article comprising the PAES (P2) may be selected from the group consisting of membranes (e.g., solution casted membranes); fibers; sheets; solution-processed films (e.g., porous films); and solution-processed monofilaments.

The PAES (P2) can be incorporated into articles having a polymeric surface. The article can have a polymeric surface, at least a portion of which comes into direct contact with an aqueous media, such as water, an aqueous solution, a biological fluid, and/or food product in its intended application setting. The polymeric surface may be an external or internal surface of the article. For example, a medical device has an external surface intended to come into direct contact with a biological fluid, such as blood, plasma, or serum. A person of ordinary skill in the art will know which surface is intended to contact a biological fluid or food product based on the article's intended application setting.

As another example, a surface of the article can comprise a coating or film comprising the PAES (P2), disposed on an underlying substrate. In such embodiments, the underlying substrate can be a structural component having a composition distinct from the PAES (P2).

In embodiments in which the PAES (P2) is in a film, the film can have an average thickness of from about 25 μm to about 1 mm.

The PAES (P2) can be included in at least a portion of a surface of the article which is intended for such surface to come in contact with a biological fluid such as blood, plasma, or serum. Alternatively, the PAES (P2) can form all, or substantially all, of the article.

A shaped article comprising the PAES (P2) preferably may be a membrane, or a part thereof, being selected from proton exchange membranes, membranes for bioprocessing (e.g., enzyme or cell culture filtration), membranes for medical filtrations, e.g., hemodialysis membranes, membranes for food and beverage processing, membranes for water purification, membranes for wastewater treatment and membranes for industrial process separations involving aqueous media.

Among membranes, the PAES (P2) according to the present invention is particularly suitable for manufacturing membranes intended for contact with an aqueous medium. The aqueous medium may include a biological fluid, such as blood, or a food product, such as beverages (e.g., fruit juice, milk).

From an architectural perspective, membranes comprising the PAES (P2) may be provided in the form of flat structures (e.g. films or sheets), corrugated structures (such as corrugated sheets), tubular structures, or hollow fibers; as per the pore size is concerned, full range of membranes (non-porous and porous, including for microfiltration, ultrafiltration, nanofiltration, and reverse osmosis) can be advantageously manufactured with the PAES (P2); the pore distribution can be isotropic or anisotropic.

Among applications of use, mention can be made of healthcare applications, in particular medical applications, wherein shaped articles comprising the PAES (P2) can advantageously be used in single-use and reusable instruments and devices.

Among applications of use, mention can be made of fuel cell applications, wherein the PAES (P2) can advantageously be used in proton exchange membranes.

The article may comprise the PAES (P2) and optionally another sulfone polymer distinct from the PAES (P2), in an amount ranging from 1 to 99 wt. %, for example from 2 to 98 wt. %, from 3 to 97 wt. % or from 4 to 96 wt. %, based on the total weight of polymers. In such instances when the article comprises the PAES (P2) and another sulfone polymer such as virgin PSU, PES, and/or PPSU, the weight fraction of the PAES (P2) based on the combined weights of PAES (P2) and the other sulfone polymer(s) in the article is at least 10 wt. %, or at least 15 wt. %, or at least 20 wt. %, or at least 25 wt. % and/or up to 99 wt. %, or up to 98 wt. %, or up to 96 wt. %, or up to 95 wt. %, or up to 90 wt. %.

### Membrane or Film (as an Article)

The article may be a film or a membrane, or a part thereof.

A particular embodiment of an article (preferably a shaped article) relates to a membrane comprising the PAES (P2). The membrane may be used for proton exchange or for purifying water, a food product, or a biological fluid, such as blood.

An embodiment of a membrane according to the invention relates to a proton exchange membrane comprising the PAES (P2).

Another embodiment of a membrane according to the invention relates to a purification membrane comprising the PAES (P2), such as for purifying water, a food product, or a biological fluid, such as blood.

A membrane may be a microporous membrane that can be characterized by its average pore diameter and porosity, i.e., the fraction of the total membrane that is porous.

The membrane may have a gravimetric porosity (%) of 20 to 90% and comprises pores, wherein at least 90% by volume of the said pores has an average pore diameter of less than 5 μm. Gravimetric porosity of the membrane is defined as the volume of the pores divided by the total volume of the membrane.

Membranes having a uniform structure throughout their thickness are generally known as symmetrical membranes; membranes having pores that are not homogeneously distributed throughout their thickness are generally known as asymmetric membranes. Asymmetric membranes are characterized by a thin selective layer (0.1-1 μm thick) and a highly porous thick layer (100-200 μm thick) which acts as a support and has little effect on the separation characteristics of the membrane.

Membranes can be in the form of a flat sheets or the form of tubes.

A membrane may be formed using a plurality of films or fibers.

Tubular membranes are classified based on their dimensions in tubular membranes having a diameter greater than 3 mm; capillary membranes, having a diameter comprised between 0.5 mm and 3 mm; and hollow fibers having a diameter of less than 0.5 mm. Capillary membranes are otherwise referred to as hollow fibers.

Hollow fibers are particularly advantageous in applications where compact modules with high surface areas are required.

The membrane, fiber, or film according to the present invention can be manufactured using any of the conventionally known membrane, fiber, or film preparation methods. For example, a film preparation method may use a solution casting method.

A membrane or film according to the present invention may be prepared by a phase inversion method occurring in a liquid phase, said method comprising the following steps: preparing a polymer solution comprising the PAES (P2) described herein and a polar solvent, processing said polymer solution into a film; and contacting said film with a non-solvent bath.

The invention will be now described in more detail with reference to the following examples whose purpose is merely illustrative and not limitative of the scope of the invention.

### EXAMPLES

The invention will be now described in more detail with reference to the following examples whose purpose is merely illustrative and not limitative of the scope of the invention. As used in the Examples, “E” denotes an embodiment of the present invention and “CE” denotes a counter-example.

### GPC Method for Measuring Mn, Mw (“Sulfone GPC Method #1”)

The molecular weights were measured by gel permeation chromatography (GPC), using methylene chloride as a mobile phase. Two 5p mixed D columns with a guard column from Agilent Technologies were used for separation. An ultraviolet detector of 254 nm was used to obtain the chromatogram. A flow rate of 1.5 ml/min and injection volume of 20 μL of a 0.2 w/v % solution in the mobile phase was selected. Calibration was performed with 10 or 12 narrow molecular weight polystyrene standards. The number average molecular weight Mn and weight average molecular weight Mw were reported and the PDI=Mw/Mn was calculated.

### Example 1: PES Recycle

### Raw Materials for Samples EJ-E2, CE3, CE4, E5

Na₂CO₃ (sodium carbonate), available from Solvay France
DCDPS (4,4′-dichlorodiphenyl sulfone), available from Solvay Speciality Polymers
DHDPS (4,4′-dihydroxydiphenyl sulfone or Bisphenol S), available from Sigma-Aldrich
Sulfolane, available from ChevronPhillips Chemicals
Methyl Chlorde available from Matheson Gas
Methanol, available from Sigma-Aldrich
PES₁: Veradel® 3000MP PES, manufactured by Solvay Specialty Polymers with Mw=64,145; Mn=19,145; PDI=3.35
   Synthesis of PES Samples E1-E2: PES Polymerization Process with 20 wt. % Added PES Used as a Reactant

For preparing PES Samples E1 and E2, the monomers DHDPS and DCDPS with a 1 mol. % excess (relative to DHDPS amount), meaning that the molar ratio of DCDPS/DHDPS was 1.01, and the Veradel® 3000MP (PES₁) was first added to a 1.0-L glass reactor vessel fitted with an overhead stirrer and a nitrogen inlet. Then sodium carbonate was added to achieve an 18% molar excess of Na₂CO₃ (relative to DHDPS amount), meaning that the molar ratio of Na₂CO₃/DHDPS was 1.18. The reaction medium was heated from room temperature to 227+/−2° C. over 90 mins. The polymerization temperature of the reaction medium was maintained for around 3.6 to 4.1 hours, depending upon the viscosity of the solution. The polymerization was carried out at a polymer concentration of 26.4 wt. % in the reaction medium. The reaction was terminated by adding methyl chloride (˜1 g/min) and end-capping the polymer at 227±2° C. for another 30 minutes. The reaction medium was quenched by dilution with sulfolane to achieve a 15 wt. % polymer content. The termination was thus carried out at polymerization temperature (227° C.) before the quench with additional sulfolane. After quenching, the reaction medium was filtered through a 2.7-μm glass fiber filter pad under nitrogen pressure and coagulated into the water with a volume ratio of polymer solution/water of 1:5 using a high-speed Waring blender. The coagulated polymer was then washed five times with hot water (70° C.) and dried at 110° C. in an oven under a vacuum overnight.

The difference between Samples E1 and E2 was that the polymerization for Sample E1 was terminated earlier (3.6 hrs) than for Sample E2 (4.1 hrs).

Synthesis for Sample CE3 (Counter-Example)—PES Polymerization Process (without PES Used as a Reactant)

For Sample CE3, the polymerization took place in the same way as described above for Samples E1 and E2, except that no PES was added to the reaction medium and the reaction time was 4.6 hrs.

The Mw, Mn, and PDI (via sulfone GPC method) of the PES polymers resulting after coagulation and drying in Samples E1, E2, and CE3 are reported in Table 1.

It was observed that the resulting polymer with added 20 wt. % PES₁ as a reactant in Sample E2 had similar Mw and Mn values to CE3 without PES₁ reactant when the reaction times were similar.

For Sample E2, there was a small reduction in Mw (−7%) relative to the control Sample CE3. This is in contrast with a loss of 35% in Mw for a shorter reaction time for sample E1 relative to the control CE3.

There was also a reduction in PDI value for Samples E1 (−25%) and E2 (−18%) relative to the control Sample CE3.

### Synthesis for Sample E4: PES Polymerization Process Using 10 wt. % PES₁ Recycle

The polymerization took place in the same way as described for Sample E2, except that the coagulated polymer for Sample E4 was further washed once with methanol after the five washes with hot water (70° C.). Additionally, only 10 wt. % of PES₁ was used to form Sample E4 (compared to 20 wt. % PES₁ in Samples E1 & E2).

Synthesis for Sample CE5 (Counter-Example)—PES Polymerization Process (without PES Addition)

The polymerization to form Sample CE5 took place in the same way as described for Sample CE3, except that the coagulated polymer was further washed once with methanol after the five washes with hot water (70° C.) to yield PES Sample CE5.

The Mw, Mn, and PDI (via sulfone GPC method) of the PES polymers resulting after coagulation and drying in Samples CE4 and E5 are also reported in TAble 1.

TABLE 1

| | wt. | | | | | | |
|---|---|---|---|---|---|---|---|
| | %* | Reaction | | % | | | % |
| PES | PES₁ | time | | change | | | change |
| sample | added | (hrs) | **Mw | in Mw | **Mn | PDI | in PDI |
| E1 | 20 | 3.6 | 30,489 | −35% | 12,707 | 2.40 | −25% |
| E2 | 20 | 4.1 | 43,420 | −7% | 16,554 | 2.62 | −18% |
| CE3 | — | 4.6 | 46,832 | — | 14,691 | 3.19 | — |
| E4 | 10 | 4.6 | 57,034 | −10% | 18,477 | 3.09 | −8% |
| CE5 | — | 4.1 | 63,306 | — | 18,800 | 3.37 | — |
| PES₁ | | n/a | 64,145 | | 19,145 | 3.35 | |

**Sulfone GPC method #1 using methylene chloride as mobile phase

It was observed that the resulting PES in Sample E4 with 10 wt. % PES₁ addition as reactant had similar Mw and Mn values to Sample CE5 without added PES₁ when the reaction conditions (including reaction times) were similar.

For Sample E4, there was a small reduction in Mw (−10%) relative to the control Sample CE5, and also a small reduction in PDI value (−8%) relative to the control Sample CE5.

### Example 2—PES Recycle

### GPC Method for Measuring Mn, Mw

The same sulfone GPC method #1 as described above was used.

### Raw Materials for Samples E6-E12 & CE13

Na₂CO₃ (sodium carbonate) available from Solvay
DCDPS (4,4′-dichlorodiphenyl sulfone) available from Solvay Speciality Polymers
DHDPS (4,4′-dihydroxydiphenyl sulfone or Bisphenol S) available from Sigma-Aldrich
Sulfolane available from ChevronPhillips Chemicals
PES₂: Veradel® 3300 PES manufactured by Solvay Specialty Polymers with Mw=45249; Mn=15244; PDI=2.97; in powder form
PES₃: Veradel® 3000MP PES manufactured by Solvay Specialty Polymers with Mw=67559; Mn=18013; PDI=3.75; in powder form
PES₄: Veradel® 3300 PES manufactured by Solvay Specialty Polymers with Mw=45735; Mn=14785; PDI=3.09; in pellet form

### Synthesis for PES Sample E6—PES Manufacture Using 100 wt. % PES Powder Recycle

PES₂ powder (Mw=45249) (232 g) was loaded in a 1.25-liter glass polymerization reactor along with 460 ml of sulfolane. This reaction medium was heated under stirring conditions at 50 RPM in a continuous flow of nitrogen. After the partial dissolution of the polymer around 100° C., 4,4′-dihydroxydiphenyl sulfone (DHDPS) (2.5 g, 0.01 mol) and sodium carbonate (6.0 g, 0.0566 mol) was added to the reaction medium. The stirring speed was increased to 200 RPM. The reaction medium was heated at 227° C. for 3.5 to 4 hours. The molecular weight growth of the polymerization was monitored via GPC. The polymerization reaction was quenched by adding 250 ml of sulfolane. Subsequently, methyl chloride was purged through the reaction medium to endcap the polymer chains for 30 minutes. The reaction medium was subjected to coagulation in 1.5-liter deionized water in a Waring blender to obtain a coagulated polymer. The coagulated polymer was washed with cold and hot water in Ace Glass Instatherm® extraction kettle until the residual solvent amount decreased to about 0.3 wt. %. The resulting washed polymer powder was dried at 120° C. for 24 hours. A mass of 212 g dried PES polymer (Sample E6) was obtained with a yield of about 91%.

### Synthesis for PES Sample E7—PES Manufacture Using 30 wt. % PES Powder Recycling

DCDPS (102.459 g, 0.357 mol), DHDPS (87.5 g, 0.35 mol), and PES₃ powder (Mw=67559) (69.6 g) were loaded in a 1.25-liter glass polymerization reactor along with 460 ml of sulfolane. The reaction medium was heated under stirring conditions at 200 RPM in a continuous flow of nitrogen. After the dissolution of the monomers at around 70° C., sodium carbonate (47.908 g, 0.413 mol) was added to the reaction medium. The reaction medium was heated at 227° C. for 4 hours. The molecular weight growth of the polymerization was monitored via GPC. The polymerization reaction was quenched by adding 250 ml of sulfolane. Subsequently, methyl chloride was purged through the reaction medium to endcap the polymer chains for 30 minutes. The reaction medium was then pressure filtered through a 2.7-micron glass fiber filter pad using an Advantec filtration system. The filtered reaction medium was subjected to coagulation in 1.5-liter deionized water in a Waring blender to obtain a coagulated polymer. The coagulated polymer was washed with cold and hot water in Ace Glass Instatherm® extraction kettle until the residual solvent amount decreased to about 0.3 wt. %. The resulting washed polymer solid was dried at 120° C. for 24 hours. A mass of 189 g dried PES polymer powder (Sample E7) was obtained with a yield of about 81%.

### Synthesis for PES Samples E8a & E8b—PES Manufacture Using 50 wt. % PES Powder Chemical Recycling

DCDPS (73.185 g, 0.255 mol) and DHDPS (62.5 g, 0.25 mol), PES₃ powder (Mw=67559) (116 g) were loaded in a 1.25-liter glass polymerization reactor along with 460 ml of sulfolane. The reaction medium was heated under stirring at 200 RPM in a continuous flow of nitrogen. After the dissolution of the monomers at around 70° C., sodium carbonate (31.27 g, 0.295 mol) was added to the reaction medium. The remaining procedure was similar to Example 6 to obtain 196 g of dried PES polymer (Sample E8a) with a yield of about 84%.

The procedure was repeated under the same conditions as described above, except using a slightly different reaction time, to produce another dried PES Sample E8b.

### Synthesis for PES Samples E9a & E9b—PES Manufacture Using 70 wt. % PES Powder Chemical Recycling

DCDPS (43.911 g, 0.153 mol), DHDPS (37.5 g, 0.15 mol), and PES₃ powder (Mw=67559) (162.4 g) were loaded in a 1.25-liter glass polymerization reactor along with 460 ml of sulfolane. The remaining procedure was similar to Example 6 to yield 186 g of dried PES polymer (Sample E9a) with a yield of about 80%.

The procedure was repeated under the same conditions as described above for Sample E9a, except using a slightly different reaction time, to produce another dried PES Sample E9b.

### Synthesis for PES Samples E10a & E10b—PES Manufacture Using 90 wt. % PES Powder Chemical Recycling

DCDPS (14.637 g, 0.051 mol) and DHDPS (12.5 g, 0.05 mol), PES₃ powder (Mw=67559) (208.8 g) were loaded in a 1.25-liter glass polymerization reactor along with 460 ml of sulfolane. The reaction medium was heated under stirring conditions at 50 RPM in a continuous flow of nitrogen. After the dissolution of the monomers and PES₃ powder at around 90° C., sodium carbonate (6.254 g, 0.059 mol) was added to the reaction medium. The stirring speed was increased to 200 RPM. The reaction medium was heated at 217° C. for 3 to 4 hours. The molecular weight growth of the polymerization was monitored via GPC. The remaining procedure was similar to Example 7 to yield 208 g of dried PES polymer Sample E10a with a yield of about 89%.

The procedure was repeated under the same conditions as described above, except using a slightly different reaction time, to produce another dried PES Sample E10b.

### Synthesis for PES Sample E11—PES Manufacture Using 95 wt. % PES Powder Chemical Recycling

DCDPS (7.318 g, 0.0255 mol), DHDPS (6.25 g, 0.025 mol), and PES₃ powder (Mw=67559) (208.8 g) were loaded in a 1.25-liter glass polymerization reactor along with 460 ml of sulfolane. The reaction medium was heated under stirring conditions at 50 RPM in a continuous flow of nitrogen. After the dissolution of the monomers and PES₃ powder at around 90° C., sodium carbonate (6.254 g, 0.059 mol) was added to the reaction medium. The remaining procedure was similar to Example 7 to obtain 206 g of dried PES polymer (Sample E11) with a yield of about 88%.

### Synthesis for PES Sample E12—PES Manufacture Using 100 wt. % PES Pellets Chemical Recycling

PES₄ pellets (Mw=45735) (232 g) were loaded in a 1.25-liter glass polymerization reactor along with 460 ml of sulfolane. The reaction medium was heated under stirring conditions at 20 RPM in a continuous flow of nitrogen. After the partial dissolution of the PES₄ pellets around 130° C., DHDPS (2.5 g, 0.01 mol) and sodium carbonate (6.0 g, 0.0566 mol) were added to the reaction medium. The stirring speed was slowly increased to 200 RPM. The reaction medium was heated at 227° C. for 3 to 4 hours. The molecular weight growth of the polymerization was monitored via GPC. The polymerization reaction was quenched by adding 250 ml of sulfolane. Subsequently, methyl chloride was purged through the reaction medium to endcap the polymer chains for 30 minutes. The reaction medium was subjected to coagulation in 1.5 liters of deionized water in a Waring blender to obtain a coagulated polymer. The coagulated polymer was washed with cold (30° C.) and hot (80° C.) water in Ace Glass Instatherm® extraction kettle until the residual solvent amount decreased to about 0.3 wt. %. The resulting washed polymer solid was dried at 120° C. for 24 hours. A mass of 208 g dried PES Sample E12 was obtained with a yield of about 89%.

Synthesis for PES Sample CEM (Counter-Example)—PES Manufacture without PES Recycling

DCDPS (146.37 g, 0.51 mol) and DHDPS (125 g, 0.50 mol) were loaded in a 1.25-liter glass polymerization reactor along with 460 ml of sulfolane. The reaction medium was heated under stirring conditions at 50 RPM in a continuous flow of nitrogen. After the dissolution of the monomers at around 70° C., sodium carbonate (63 g, 0.59 mol) was added to the reaction medium. The stirring speed was increased to 200 RPM. The reaction medium was heated at 227° C. for 3 to 4 hours. The remaining procedure was similar to Example 7 to yield 197 g of dried PES Sample CE13 with a yield of about 84.9%.

The Mw, Mn, and PDI (via sulfone GPC method #1 as described above) of the PES Samples E6 to E12 and CE13 resulting after coagulation and drying are reported in Table 2.

TABLE 2

| | Type of | recycle | molar | | | | |
|---|---|---|---|---|---|---|---|
| Sam- | PES | ratio | DCDPS/ | Time | | | |
| ple | added | wt. % | DHDPS | hr | **Mw | **Mn | PDI |
| E6 | PES₂ | 100 | 0 | 3.5 | 46177 | 15193 | 3.04 |
| | (powder) | | | | | | |
| E7 | PES₃ | 30 | 1.02 | 4 | 48901 | 15237 | 3.21 |
| E8a | PES₃ | 50 | 1.02 | 4 | 43774 | 14450 | 3.03 |
| E8b | PES₃ | 50 | 1.02 | 3.75 | 44233 | 14436 | 3.06 |
| E9a | PES₃ | 70 | 1.02 | 3.75 | 48022 | 15108 | 3.17 |
| E9b | PES₃ | 70 | 1.02 | 3 | 44746 | 14614 | 3.06 |
| E10a | PES₃ | 90 | 1.02 | 2.8 | 47635 | 15091 | 3.16 |
| E10b | PES₃ | 90 | 1.02 | 4.5 | 43763 | 14587 | 3 |
| E11 | PES₃ | 95 | 1.02 | 3 | 44039 | 14709 | 2.99 |
| E12 | PES₄ | 100 | 0 | 4 | 44978 | 14825 | 3.03 |
| | (pellets) | | | | | | |
| CE13 | — | — | 1.02 | 4 | 45676 | 15644 | 2.92 |

**sulfone GPC method #1 using methylene chloride as mobile phase

For PES Samples E7-E12, there was only a small change in Mw (from −4.2% to 7.1%) relative to the control Sample CE13. There was also a slight increase in PDI value by 2.4% to 9.9% relative to the control Sample CE13.

### Example 3: PES Recycle

### GPC Method for Measuring Mn, Mw

The same sulfone GPC method #1 as described above was used.

### Raw Materials for Samples E14 & E15

Na₂CO₃ (sodium carbonate) available from Solvay
DHDPS (4,4′-dihydroxydiphenyl sulfone or Bisphenol S) available from Sigma-Aldrich
Sulfolane, available from ChevronPhillips Chemicals
PES₅: Ultrason® E020 PES manufactured by BASF with Mw=66842 g/mol; Mn=20205 g/mol; PDI=3.3 in form of flakes

### Synthesis for Sample E14—PES Manufacture Using 100 wt. % PES Pellet Recycle

PES₅ powder (Mw=66842) 40 g was slowly added in a 250 ml-four neck round bottom flask containing 80 ml of sulfolane. The reaction medium was heated under stirring conditions at 50 RPM in a continuous flow of nitrogen. After the complete dissolution of the PES₅ polymer, the stirring speed was increased to 200 RPM. Once the reaction temperature reached 220° C., 4,4′-Dihydroxydiphenyl sulfone (DHDPS) (0.431 g, 1.7 mmol) and sodium carbonate (0.91 g, 8.5 mmol) were added to the reaction medium. The reaction medium was heated at 227° C. for ˜3.5 h. Molecular weight growth of the polymerization was monitored via GPC (with methylene chloride as the mobile phase). At first, the PES₅ polymer was depolymerized from Mw-66842 Da to Mw-34490 Da, then re-polymerized into a molecular weight Mw of 44258 Da. The polymerization reaction was quenched by adding −45 ml of sulfolane. Subsequently, MeCl was purged through the reaction medium to endcap the polymer chains for 30 minutes. The reaction mass was coagulated in 1.2-liter deionized (MilliQ) water in a Waring blender. The resulting polyarylether polymer powder was extracted with cold and hot water in Ace Glass Instatherm® extraction kettle until the residual solvent amount came down to below ˜0.3 wt. %. A polymer powder was dried at 120° C. for 24 hours.

The Mw, Mn, and PDI of the PES polymer Sample E14 resulting after coagulation and drying and compared to the starting PES material: PES₅ which was added to the reaction medium to make Sample E14 are reported in Table 3.

TABLE 3

| | | recycle | molar | | | | |
|---|---|---|---|---|---|---|---|
| PES | PES | ratio | DCDPS/ | Time | | | |
| sample | added | wt. % | DHDPS | hr | **Mw | **Mn | PDI |
| E14 | PES₅ | 95 | 0 | 3.5 | 44258 | 12985 | 3.4 |
| PES₅ | — | — | — | — | 66842 | 20205 | 3.3 |

**sulfone GPC method #1 using methylene chloride as mobile phase

For Sample E14 sample with close to 100% PES recycle, there was a reduction in Mw (−34%) relative to the initial PES₅ polymer. There was also a very small increase in PDI value by 3% relative to the PES₅ polymer.

### Example 4: PES-Based Membrane Fiber Recycle

### GPC Method for Measuring Mn, Mw

Same sulfone GPC method #1 as described above was used.

### Raw Materials for Sample E1S

Na₂CO₃ (sodium carbonate), available from Solvay
DHDPS (4,4′-dihydroxydiphenyl sulfone or Bisphenol S), available from Sigma-Aldrich
Sulfolane, available from ChevronPhillips Chemicals
PES₆: Hollow fiber dialyzer DORA B-13PF from Bain medical equipment (GuangZhou) Co. LTD based on PES of Mw=66619, Mn=21277, PDI=3.13. Elemental analysis was made with an Elementar Vario MICRO cube CHNS analyzer. The PVP content in the PES-based membrane fibers was found to be −5 wt. %.

### Synthesis for Sample E15—PES Manufacture Using PES-Based Hemodialysis Membrane Filter (100 wt. % Recycle)

Hemodialysis PES₆ membrane fibers (Mw=66619 Da) were used as a reactant for Sample E15. The fibers (42 g) were cut into small pieces and slowly added to a 250 mL-four neck round bottom flask containing 80 ml of sulfolane. To the reactor, 4,4′-dichlorodiphenylsulphone (DCDPS) (1.25 g, 4.38 mmol), 4,4′-Dihydroxydiphenyl sulfone (DHDPS) (1.075 g, 4.3 mmol) were then added. The reaction medium was heated at 180° C. under stirring conditions at 50 RPM in a continuous flow of nitrogen. After complete dissolution of the fibers and monomers, the stirring speed was increased to 200 RPM. Once the reaction temperature reached 220° C., sodium carbonate (2.32 g, 21.9 mmol) was added to the reaction medium. The reaction medium was heated at 227° C. for ˜4.5 h. The molecular weight growth of the polymerization was monitored via GPC. At first, the polymer was depolymerized from Mw-66619 Da to Mw-22865-Da and then re-polymerized into the desired molecular weight of 45500-Da.

The polymerization reaction was quenched by adding −45 mL of sulfolane. Subsequently, MeCl was purged through the reaction medium to end cap the polymer chains for 30 minutes. The reaction mass was coagulated in 1.2-liter deionized (Milli Q) water in a Waring blender. A polymer powder was extracted with cold and hot water in Ace Glass Instatherm® extraction kettle until the residual solvent amount came down to below ˜0.3 wt. %. The polymer powder was dried at 120° C. for 24 hrs.

The Mw, Mn, and PDI of the PES polymer Sample E15 resulting after coagulation and drying are reported in Table 4 and compared to the starting PES material: PES₆ material which was added to the reaction medium to make Sample E15.

TABLE 4

| | | wt. % | molar | | | | |
|---|---|---|---|---|---|---|---|
| PES | PES | recycle | DCDPS/ | Time | | | |
| sample | added | ratio | DHDPS | hr | **Mw | **Mn | PDI |
| E15 | PES₆ | 100 | 0 | 4.5 | 46824 | 14715 | 3.18 |
| PES₆ | — | — | — | — | 66619 | 21277 | 3.13 |

**GPC (Sulfone) method using methylene chloride as mobile phase

For Sample E15 sample with 100 wt. % PES₆ recycle, there was a reduction in Mw (−30%) relative to the initial PES₆ polymer. There was also a very small increase in PDI value by 1.6% relative to the recycled PES₆ polymer.

### Example 5: PSU Recycle and PSU/PVP Recycle

### Test Methods

### GPC Method for Measuring Mn, Mw

Same sulfone GPC method #1 as described above was used.

### Thermal Gravimetric Analysis (TGA)

TGA experiments were carried out using a TA Instrument TGA Q500. TGA measurements were obtained by heating the sample at a heating rate of 10° C./min from 20° C. to 800° C. under nitrogen.

### DSC

DSC was used to determine glass transition temperatures (Tg) and melting points (Tm)—if present. DSC experiments were carried out using a TA Instrument Q100.

DSC curves were recorded by heating, cooling, re-heating, and then re-cooling the sample between 25° C. and 320° C. at a heating and cooling rate of 20° C./min. All DSC measurements were taken under a nitrogen purge. The reported Tg values (and if any, Tm values) were provided using the second heat curve unless otherwise noted.

### Elemental Analysis

The elemental composition of some polymer samples was determined using a Perkin Elmer 2400 CHN Element Analyzer. The polymer samples were combusted based on the classical Pregl-Dumas method. The resultant combustion gases were completely reduced to CO₂, H₂O, N₂, and SO₂. Then the gases were separated via Frontal Chromatography. As the gases eluted they were measured by a thermal conductivity detector to determine quantitative amounts of Carbon, Hydrogen, Nitrogen, and Sulfur.

### Quantification of PVP by ^{H}NMR Analysis

Samples are dissolved in deuterated 1,1,2,2-tetrachloroethane. All samples were run on a Bruker 400 MHz NMR, with a D1 set to 15 seconds and 64 scans. Data were processed using MestReNova software. Integrations of relevant peaks were performed and the following equations were used to determine the weight percent (wt. %) of PVP in the sample:

$$mol PVP = \frac{\frac{( \int PVP - \int PSU )}{\# H PVP}}{( \frac{( \int PVP - \int PSU )}{\# H PVP} + \frac{\int PSU}{\# H PSU} )}$$

$$wt \% PVP = \frac{( mol PVP ) ( molecular weight PVP )}{( g PVP + g PSU )} ( 100 )$$

in which
∫PVP and would denote the sum of all the hydrogen protons of PVP;
∫PSU would denote the sum of all the hydrogen protons of PVP between 7 to 9 ppm;
#H PVP and #H PSU denote the number of protons corresponding to the PVP and PSU molecules;
molecular weight of PVP=111.1 g/mol; and
g PVP+g PSU=weight of the sample;

### Raw Materials for Samples CE16-E21

N-methylpyrrolidone (NMP) available from Sigma-Aldrich
K₂CO₃ (Potassium Carbonate) available from Armand Products
Bisphenol A “BPA” (4,4′-dihydroxydiphenyl sulfone), available from Covestro
DCDPS (4,4′-dichlorodiphenyl sulfone), available from Solvay Speciality Polymers
Methyl chloride available from Matheson gas
Methanol available from Sigma-Aldrich
PSU₁: Udel® P-3500 pellets (Lot No. P060467C) manufactured by Solvay Specialty Polymers USA with Mw=78213 g/mol; Mn=21996 g/mol; PDI=3.55 measured via the sulfone GPC method #1
DSC=190.14° C.
TGA=505.5° C.

PSU₂: Udel® P-3500 (Lot No. 1901009833) in pellet form, manufactured by Solvay Specialty Polymers USA with Mw=77267 g/mol; Mn=22542 g/mol;
PDI=3.42
DSC=190.72° C.
TGA=501.2° C.

PSU₃: Fibers based on PSU-PVP based hemo-dialyzer from D. Braun
Mw=82969 g/mol, Mn=22907 g/mol, PDI=3.6
DSC=186.7° C.
TGA=516.1° C.
PVP content: 3.89 wt. % by ^{H}NMR
C: 71.97%
H: 5.15%
N: 0.45%

PVP (Polyvinyl Pyrrolidone) available from Alf Aesar with Mw=371165 g/mol, Mn=139881 g/mol, PDI=2.65 determined by the following GPC method #3:

Viscotek GPC Max (Autosampler, pump, and degasser) with a TDA302 triple detector array comprised of RALS (Right Angle Light Scattering), RI (Refractive Index), and Viscosity detectors were used. Samples were prepared as ˜2 mg/mL in DMAc/LiBr. Samples were run in NMP with 0.2 w/w % LiBr at 65° C. at 1.0 mL/min through a set of 3 columns: a guard column (CLM1019—with a 20k Da exclusion limit), a high Mw column (CLM1013 exclusion of 10MM Daltons relative to Poly Styrene) and a low Mw column (CLM1011—exclusion limit of 20k Daltons relative to PS). Calibration was done with a single, mono-disperse polystyrene standard of ˜100k Da. Light Scattering, RI, and Viscosity detectors were calibrated based on a set of input data supplied with the standards. Samples were prepared as about 2 mg/mL in NMP/LiBr. Viscotek's OMNISec v4.6.1 Software was used for data analysis.

The PVP had a DSC value of 174.48° C. (Tg) and an onset of degradation temperature (via TGA) of 401° C.

### Synthesis of Sample CE16 (Counter-Example): Baseline PSU Producdon in NMP

Bisphenol A=BPA (182.63 g), DCDPS (229.72 g), K₂CO₃ (120.5 g), and NMP (532 g) were charged to a 1-L 4-necked resin kettle equipped with an overhead stirrer, a nitrogen inlet, thermocouple, and a dean-stark trap with a condenser. The respective weights of the ingredient used in the reaction medium are provided in TA. The DCDPS/BPA molar ratio used in the reaction was 1.096 and the K₂CO₃/BPA molar ratio was 1.09. The reactor was slowly heated with low agitator rpm was used to mix the material. The heating ramp rate was about 2.5-3° C./min till 190° C. When the temperature reached 190° C., the water of condensation was collected in the Deanstark trap. After the pre-determined torque or polymerization time had been reached, the reaction was stopped by terminating by passing excess methyl chloride. The cooled reaction medium was then filtered to remove the KCl salts and then coagulated into methanol and the coagulated polymer was washed with hot water (70° C.) and methanol and then dried in a vacuum oven at 110° C. for 12 hours.

This method yielded a baseline PSU Sample CE16, and its Mw, Mn, PDI (using the GPC sulfone method), TGA data, and Tg (via DSC) are provided in Table 6.

Synthesis of Sample E17: PSU Production with 25 wt. % PSU Recycling in NMP

The synthesis was carried out using the same method as described for CE16, except that Udel® PSU P-3500 pellets (PSU₁) were additionally charged to the 1-L 4-necked resin kettle to achieve a PSU recycle ratio of 25 wt. %. The respective weights of the ingredients are provided in II The DCDPS/BPA molar ratio used in the reaction was 1.096 and the K₂CO₃/BPA molar ratio was 1.09. This yielded a PSU sample E17, and its Mw, Mn, PDI (using the GPC sulfone method), TGA data, and Tg (via DSC) are provided in Table 6.

Elemental Analysis of sample E17: C=72.43%, H=4.88%, N<0.05%

Synthesis of Sample E18: PSU Production with 75% PSU Recycle Ratio in NMP

The synthesis was carried out using the same method as described for CE16, except that Udel® PSU P-3500 pellets (PSU₁) were additionally charged to the 1-L 4-necked resin kettle to achieve a PSU recycle ratio of 75 wt. %. The respective weights of the ingredients are provided in Table 5. The DCDPS/BPA molar ratio used in the reaction was 1.096 and the K₂CO/BPA molar ratio was 1.09. This yielded a PSU sample E18, and its Mw, Mn, PDI (using the sulfone GPC method), TGA data, and Tg (via DSC) are provided in Table 6.

Elemental Analysis of sample E18: C=72.63%: H=5.09%; N<0.05%

Synthesis of Sample E19: PSU Production Containing 5 Wt. % PVP with 25 wt. % PSU Recycling in NMP

The synthesis was carried out using the same method as described for CE16, except that Udel® PSU P-3500 pellets (PSU₁) and PVP were additionally charged to the 1-L 4-necked resin kettle to achieve a PSU recycle ratio of 25 wt. %. The respective weights of the ingredients are provided in Table 5. The DCDPS/BPA molar ratio used in the reaction was 1.096 and the K₂CO₃/BPA molar ratio was 1.09. This yielded a PSU sample E19, and its Mw, Mn, PDI (using the sulfone GPC method), TGA data, and Tg (via DSC) are provided in Table 6.

The elemental analysis of sample E19 (C=72.4%, H=5.13%, N=0.09%) confirmed the presence of PVP in the resulting PSU sample E19. The PVP was present in the final PSU sample E19 as being physically and chemically bound PVP to the PSU polymer matrix.

Synthesis of Sample E20: Production of PSU/PVP Containing 5 Wt. % PVP with 75 wt. % PSU Recycling in NMP

The synthesis was carried out using the same method as described for CE16, except that Udel® PSU P-3500 pellets (PSU₂) and PVP were additionally charged to the 1-L 4-necked resin kettle to achieve a PSU recycle ratio of 75 wt. %. The respective weights of the ingredients are provided in Table 5. The DCDPS/BPA molar ratio used in the reaction was 1.096 and the K₂CO₃/BPA molar ratio was 1.09. This yielded a PSU sample E20, and its Mw, Mn, PDI (using the GPC sulfone method), TGA data, and Tg (via DSC) are provided in Table 6.

Elemental Analysis for sample E20: C=72.2%, H=5.08%, N=0.28% confirmed the presence of PVP in the resulting PSU sample E20. The PVP was present in the final PSU sample E20 as being physically and chemically bound PVP to the PSU polymer matrix.

Synthesis of Sample E21: Production of PSU with 25% Braun Dialyzer Fibers in NMP

The synthesis was carried out using the same method as described for CE16, except that the fibers from Braun Dialyzer (PSU₃) were additionally charged to the 1-L 4-necked resin kettle to achieve a PSU recycle ratio of 25 wt. %. The respective weights of the ingredients are provided in Table 5. The DCDPS/BPA molar ratio used in the reaction was 1.096 and the K₂CO₃/BPA molar ratio was 1.09. This yielded a PSU sample E21, and its Mw, Mn, PDI (using the GPC sulfone method), TGA data, and Tg (via DSC) are provided in Table 6.

TABLE 5
Composition of reaction medium

| | | wt. % | | | | | | |
|---|---|---|---|---|---|---|---|---|
| | Type | re- | | | | | | |
| | PSU | cycle | PSU | DCDPS | DHDPS | K₂CO₃ | PVP | NMP |
| | added | ratio | (g) | (g) | (g) | (g) | (g) | (g) |
| CE16 | — | — | | 229.72 | 182.63 | 120.5 | — | 532 |
| E17 | PSU₁ | 25 | 88.50 | 172.28 | 136.96 | 90.4 | — | 532 |
| E18 | PSU₁ | 75 | 265.5 | 57.43 | 45.65 | 30.13 | — | 532 |
| E19 | PSU₁ | 25 | 88.50 | 172.31 | 137 | 90.4 | 4.4 | 532 |
| E20 | PSU₂ | 75 | 265.52 | 57.45 | 45.69 | 30.32 | 13.29 | 531 |
| E21 | PSU₃ | 25 | 88.5* | 172.32 | 136.97 | 90.4 | 3.36 | 532 |

*this amount of PSU₃ fibers includes about 3.89 wt. % of PVP

TABLE 6

| | PSU | recycle | | | | | | |
|---|---|---|---|---|---|---|---|---|
| | type | ratio | wt. % | | | | DSC | TGA |
| | added | (wt. %) | PVP | **Mw | **Mn | PDI | (° C.) | (° C.) |
| PSU₁ | | | — | 78213 | 21996 | 3.55 | 190.1 | 505.5 |
| PSU₂ | | | — | 77267 | 22542 | 3.42 | 190.7 | 501.2 |
| CE16 | 0 | 0 | 0 | 79370 | 25343 | 3.13 | 190.9 | 513.4 |
| E17 | PSU₁ | 25 | 0 | 80856 | 22124 | 3.65 | 190.4 | 514.2 |
| E18 | PSU₁ | 75 | 0 | 89810 | 22534 | 3.98 | 190.7 | 504.8 |
| E19 | PSU₁ | 25 | 5 | 73489 | 20937 | 3.51 | 189.4 | 493.1 |
| E20 | PSU₂ | 75 | 5 | 71295 | 21819 | 3.26 | 182.3 | 507.7 |
| E21 | PSU₃ | 25 | 3.36 | 84737 | 24490 | 3.46 | 183.8 | 518.61 |
| PSU₃ | | | 3.89 | 82969 | 22907 | 3.6 | 186.7 | 516.1 |

**sulfone GPC method #1 using methylene chloride as mobile phase

Elemental Analysis for sample E21: C=72.53%, H=5.31%, N=0.11% confirmed the presence of PVP in the resulting PSU sample E21. The PVP was present in the final PSU sample E21 as being physically and chemically bound PVP to the PSU polymer matrix.

### Example 6: PPSU Recycle

GPC Method for Measuring Mn. Mw (Sulfone GPC Method #2)

The following sulfone GPC method #2 was used for Samples E22-25._The molecular weights were measured by gel permeation chromatography (GPC), using methylene chloride as a mobile phase. Two 5μ mixed D columns with a guard column from Agilent Technologies were used for separation. An ultraviolet detector of 254 nm was used to obtain the chromatogram. A flow rate of 1.5 ml/min and injection volume of 15 μL of a 0.2 w/v % solution in the mobile phase was selected. Calibration was performed with 10-point narrow molecular weight polystyrene standards. The injection volume for calibration standards was 75 μL. The number average molecular weight Mn and weight average molecular weight Mw were reported, and the PDI=Mw/Mn was calculated.

### Raw Materials for Samples E22-E25

Anhydrous Sulfolane available from Chevron Philiips Chemicals
DMI (1,3-dimethyl-2-imidazolidinone) available from TCI Americas
NMP (N-methylpyrrolidone) available from Sigma-Aldrich
Anhydrous K₂CO₃ (potassium carbonate) of average particle size 30-40 μm available from Armand Products
biphenol (4,4′-biphenol) available from Sigma-Aldrich
DCDPS (4,4′-dichlorodiphenyl sulfone) available from Solvay Speciality Polymers USA
Methyl chloride available from Matheson Gas
MCB (Monochlorobenzene) available from Sigma-Aldrich
Methanol available from Sigma-Aldrich
PPSU₁: PPSU in coagulated form manufactured by Solvay Speciality Polymers USA of Mw=60,925 g/mol, Mn=28,501 g/mol, PDI=2.14
PPSU₂: Radel R-5600 P NT PPSU in ground powder form available from Solvay Speciality Polymers USA of Mw=46,720 g/mol, Mn=20,104 g/mol, PDI=2.32.
PPSU₃: PPSU in coagulated form manufactured by Solvay Specialty Polymers USA of Mw=79,859 g/mol, Mn=34,451 g/mol, PDI=2.32
PPSU₄: PPSU in coagulated form manufactured by Solvay Speciality Polymers USA of Mw=69,652 g/mol, Mn=31,259 g/mol, PDI=2.23
PPSU₅: PPSU in coagulated form manufactured by Solvay Speciality Polymers USA of Mw=69,420 g/mol, Mn=31,334 g/mol, PDI=2.22

### Synthesis Method for PPSU₁

To a 1-L 4-necked resin kettle equipped with an overhead stirrer, a nitrogen inlet, thermocouple, and a Dean-Stark trap with a condenser was charged biphenol, 130.34 g (0.70 mol), DCDPS, 203.02 g (0.707 mol), and anhydrous potassium carbonate, 101.58 g (0.735 mol). 420.48 g of DMI was added to the reactor. The reaction medium was stirred and heated via an external oil bath to an internal temperature of 200° C. over −90 minutes. The water of the reaction was collected in the dean-stark trap during the heat-up. After a pre-determined torque was reached the reaction medium was bubbled through gaseous methyl chloride for 30 min (˜1 g/min). 323 g of NMP was added to dilute the reaction medium. The reaction medium was pressured filtered through a 2.7 μm glass fiber filter pad to remove the salts. The polymer solution was coagulated into methanol using a 1:5 polymer to methanol ratio using a Waring high-speed blender. The coagulated polymer was washed with methanol five times. The coagulated form was dried in a vacuum oven at 120° C. for 12-20 hours and analyzed for Mw, Mn, and PSI. The coagulated form was used in this example.

Synthesis method for PPSU₄, PPSU₅

To a 1-L 4-necked resin kettle equipped with an overhead stirrer, a nitrogen inlet, thermocouple, and a Dean-Stark trap with a condenser was charged biphenol, 83.80 g (0.45 mol), DCDPS, 131.17 g (0.4568 mol), and anhydrous potassium carbonate, 71.52 g (0.5175 mol). The contents were evacuated/purged three times using vacuum/nitrogen cycles. 420.48 g of sulfolane was added to the reactor. The reaction medium was stirred and heated via an external oil bath to an internal temperature of 210° C. over −90 minutes. The water of the reaction was collected in the dean-stark trap during the heat-up. After a pre-determined torque was reached the reaction medium was bubbled through gaseous methyl chloride for 30 min (˜1 g/min). 723.6 g of MCB and 61.92 g of sulfolane were added to dilute the reaction medium. The reaction medium was pressured filtered through a 2.7 μm glass fiber filter pad to remove the salts. The polymer solution was coagulated into methanol using a 1:5 polymer to methanol ratio using a Waring high-speed blender. The coagulated polymer was washed with methanol five times and then dried in a vacuum oven at 120° C. for 12-20 hours.

### Synthesis Method for PPSU₃

A 60-gallon Hasteloy reactor vessel was charged with sulfolane followed by the addition of biphenol, potassium carbonate, and DCDPS. DCDPS/biphenol molar ratio of 1.015 was used along with an 11 mol. % excess of potassium carbonate, relative to biphenol. Sulfolane was charged to achieve a 30 wt. % polymer concentration. The polymerization was carried out at 210° C. until the desired polymerization endpoint was achieved. MCB was added to quench the reaction followed by charging MeCl to terminate/endcap the polymerization. The reaction mixture was diluted with MCB and sulfolane to 10% polymer concentration. About 1-liter of the reaction mixture sample was pressure filtered to remove salts and coagulated/dried as described earlier.

General synthesis for PPSU Samples E22-E25:

Biphenol, DCDPS, a PPSU material (as reactant), K₂CO₃, and sulfolane were charged to a 1-L 4-necked resin kettle equipped with an overhead stirrer, a nitrogen inlet, thermocouple, and a Dean-Stark trap with a condenser to achieve a DCDPS/biphenol molar ratio of 1 or 1.015 (for E23) and a K₂CO₃/biphenol molar ratio of 1.15. The targeted polymer content in the reaction medium was 30 wt. %. Then the reactor was slowly heated (via an externally controlled oil bath) with stirring was used to mix the reaction medium. The reaction medium was heated to 210° C. over −90 minutes. After a pre-determined torque or polymerization time has been reached, gaseous MeCl was bubbled through the reaction medium for end-capping for 30 min at approximately 1 g/min. A mixture of 859 g of monochlorobenzene and 42 g of sulfolane was added to the polymerization mixture. The cooled reaction medium was then pressure-filtered to remove the formed KCl and unreacted K₂CO₃ salts and then coagulated into methanol using a 1:5 polymer to methanol ratio using a Waring high-speed blender. The coagulated polymer was washed with methanol five times and then dried in a vacuum oven at 120 and then d-20 hours.

The respective weights of the ingredients for PPSU Samples E22-E25 are provided in Table 7.

TABLE 7
Composition of reaction medium

| | Type | recycle | | | | | |
|---|---|---|---|---|---|---|---|
| | PPSU | ratio | PPSU | DCDPS | Biphenol | K₂CO₃ | Sulfolane |
| Sample | added | wt. % | (g) | (g) | (g) | (g) | (g) |
| E22 | PPSU₁ | 25 | 45.05 | 96.9 | 62.8 | 53.6 | 420.5 |
| E23 | PPSU₂ | 50 | 90.1 | 65.6 | 41.9 | 35.8 | 420.5 |
| E24 | PPSU₃ | 75 | 135.15 | 32.3 | 20.95 | 17.88 | 420.5 |
| E25 | PPSU₄ | 90 | 81.1 | 12.92 | 8.38 | 7.15 | 420.5 |
| | PPSU₅ | | 81.1 | | | | |

The Mw, Mn, and PDI (using the GPC sulfone method #2) of the resulting PPSU Samples E22-E25 are reported in Table 8.

TABLE 8

| | PPSU | recycle | | | |
|---|---|---|---|---|---|
| | type | ratio | | | |
| | added | (wt. %) | **Mw | **Mn | PDI |
| PPSU₁ | — | — | 60925 | 28501 | 2.14 |
| E22 | PPSU₁ | 25 | 58864 | 26543 | 2.14 |
| PPSU₂ | — | — | 48720 | 20104 | 1.64 |
| E23 | PPSU₂ | 50 | 60545 | 28643 | 2.77 |
| PPSU₃ | — | — | 79859 | 34451 | 2.32 |
| E24 | PSSU₃ | 75 | 75107 | 32482 | 2.31 |
| PPSU₄ | — | — | 69652 | 31259 | 2.23 |
| PPSU₅ | — | — | 69420 | 31334 | 2.22 |
| E25 | PSSU₄ + | 90 | 67588 | 28604 | 2.36 |
| | PSSU₅ | | | | |

**sulfone GPC method #2 using methylene chloride as mobile phase

### Example 7: PSU Manufacture Using 10 or 50 wt % PSU Recycle Radio

### GPC Method for Measuring Mn, Mw

The GPC sulfone method #1 was used in this example.

### Raw Materials for Samples CE27-CE29 & E30-E32

DMSO (dimethylsulfoxide) available from Fisher-Scientific
NaOH (sodium hydroxide) available from Fisher-Scientific
Bisphenol A “BPA” (4,4′-dihydroxydiphenyl sulfone), available from Hexion
DCDPS (4,4′-dichlorodiphenyl sulfone) available from Solvay Speciality Polymers USA
MeCl (methyl chloride) available from Matheson Gas
PSU₇: Udel® P-3500 PSU in pellet form available from Solvay Speciality Polymers USA of Mw=78385 g/mol, Mn=22755 g/mol, PDI=3.44.

### Strong Alkali Synthesis for Samples CE27-CE29 & E30-E32

PSU pellets (reactant) and a blend of DMSO+MCB (319 g) were charged to a 1-L 4-necked resin kettle (reactor) equipped with an overhead stirrer, a nitrogen inlet, thermocouple, Barrett trap, and reflux condenser. A pressure equalizing funnel containing the caustic solution was attached to the head of the kettle. The reactor was purged with nitrogen until the PSU pellets dissolved. For samples made with a 10 wt. % PSU recycle ratio, the PSU pellets were dissolved at ambient temperature, and for the samples made with a 50 wt. % PSU recycle ratio, the PSU pellets were dissolved at 40° C. Upon dissolution, Bisphenol A was added to the kettle, the reaction medium was purged for 15 minutes and then heated to reflux, during which time the caustic was added to the reaction medium. Upon reflux, the reaction medium was allowed to dehydrate through the removal of a water/MCB mixture. During dehydration, a solution of DCDPS in MCB (129 g) was prepared in a heated pressure-equalizing funnel. Upon removal of all water added and formed in the reaction, the DCDPS solution was added to the kettle.

After a pre-determined torque or polymerization time has been reached, the mixture is diluted with 400 g MCB, while gaseous MeCl was bubbled through the reaction medium at approximately 1 g/min for 30 min for end-capping. Upon cooling, the reaction medium was further diluted with 400 g MCB and pressure-filtered to remove the formed NaCl salt. The filtered polymer solution was then coagulated into methanol using a 1:5 polymer to methanol ratio using a Waring high-speed blender. The coagulated polymer was washed with methanol five times and then dried in a vacuum oven at 120° C. for 12-20 hours.

The respective weights of the ingredients for PSU Samples CE27-CE29 & E30-E32 are provided in Table 10.

TABLE 10
Composition of reaction medium

| | recycle | | | | | molar | molar | |
|---|---|---|---|---|---|---|---|---|
| | ratio | PSU₇ | DCDPS | BPA | NaOH | DCDPS/ | NaOH/ | DMSO |
| | wt. % | (g) | (g) | (g) | (g) | BPA * | BPA ** | (g) |
| CE27 | — | — | 143.6 | 114.1 | 39.9 | 1.0005 | 1.9959 | 247.7 |
| CE28 | — | — | 143.6 | 114.1 | 39.9 | 1.0005 | 1.9959 | 247.7 |
| CE29 | — | — | 143.6 | 114.1 | 39.9 | 1.0005 | 1.9959 | 247.7 |
| E30 | 10 | 22.1 | 129.2 | 102.7 | 36.1 | 1.0001 | 2.0063 | 247.7 |
| E31 | 10 | 22.1 | 129.2 | 102.7 | 36.1 | 1.0001 | 2.0063 | 247.7 |
| E32 | 50 | 110.6 | 71.8 | 57.1 | 20.9 | 0.9997 | 2.0892 | 247.7 |

* DCDPS/BPA molar ratio using MW_{DCDPS} = 287.16 g/mol; MW_{BPA} = 228.29 g/mol
** NaOH/BPA molar ratio using MW_{BPA} = 228.29 g/mol; MW_{NaOH} = 39.997 g/mol

The Mw, Mn, and PDI for the resulting PSU Samples CE27-CE29 & E30-E32 are reported in Table 11.

TABLE 11

| | PSU type | PSU recycle | | | |
|---|---|---|---|---|---|
| | added | ratio (wt. %) | **Mw | **Mn | PDI |
| PSU₇ | | | 78385 | 22755 | 3.44 |
| CE27 | — | — | 76310 | 20593 | 3.71 |
| CE28 | — | — | 73610 | 22237 | 3.31 |
| CE29 | — | — | 77918 | 22711 | 3.43 |
| E30 | PSU₇ | 10 | 78543 | 22979 | 3.42 |
| E31 | PSU₇ | 10 | 77182 | 22979 | 3.42 |
| E32 | PSU₇ | 50 | 59231 | 18863 | 3.14 |

**sulfone GPC method #1 using methylene chloride as mobile phase

Accordingly, the scope of protection is not limited by the description set out above but is only limited by the claims which follow. Each and every claim is incorporated into the specification as an embodiment of the present invention. Thus, the claims are a further description and are an addition to the preferred embodiments of the present invention.

1. A process for producing a polyarylethersulfone (P2) using a recycled polymeric material comprising a polyarylethersulfone (P1) as a reactant, comprising
adding a polar aprotic solvent (S) to a reactor vessel;
adding a recycled polymeric material containing a polyarylethersulfone (P1) to the reactor vessel;
adding an alkali salt-forming agent (A) to the reactor vessel;
adding at least one monomer (M) selected from the group consisting of at least one aromatic diol monomer (AA) and at least one aromatic dihalo monomer (BB) to the reactor vessel;
whereby said adding steps form a reaction medium (RM) comprising the recycled polymeric material containing the polyarylethersulfone (P1), the at least one monomer (M), the alkali salt-forming agent (A), and the polar aprotic solvent (S),
heating the reaction medium to reach a reaction temperature of at least 150° C. and at most 290° C. to form a polyarylethersulfone (P2); and
separating the formed polyarylethersulfone (P2) from the reaction medium;
wherein the alkali salt-forming agent (A) is an alkali metal carbonate and/or an alkali metal hydroxide; and
wherein the polyarylethersulfone (P1) comprises at least 50 wt. %, based on the total weight of the PAES (P1), of a sulfone polymer selected from the group consisting of:
PPSU,
PSU,
PES,
sulfonated PSU (sPSU),
sulfonated PES (sPES),
sulfonated PPSU (sPPSU),
any polymer derived from a diol monomer selected from isosorbide and/or tetramethyl bisphenol F and a dihalo monomer selected from sulfonated dihalodiphenylsulfone and/or dihalodiphenylsulfone,
any copolymer derived from at least two diols selected from biphenol, bisphenol A, bisphenol S, isosorbide, tetramethyl bisphenol F, and/or hydroquinone and a dihalo monomer selected from sulfonated dihalodiphenylsulfone and/or dihalodiphenylsulfone,
a block polymer in the form A-B or A-B-A, comprising at least one block having one recurring unit selected from those of formulae (L), (L′), (N), (N′), (O), (O′), (Q), (Q′), and at least one block having one recurring unit selected from those of formulae (T), (T′), (U), (U′), (V), (V′), (W), (W′), (U*), (V*), (W*);
a block copolymer in the form A-B or A-B-A, comprising at least one block having one recurring unit selected from those of formulae (L), (L′), (N), (N′), (O), (O′), (Q), (Q′), and at least one polyalkylene oxide or polyvinylpyrrolidone (PVP) block, such as a PEG block, PPG block or a PVP block; and
any combination of two or more thereof,
wherein the formulae (L), (L′), (N), (N′), (O), (O′), (Q), (Q′), (T), (T′), (U), (U′), (V), (V′), (W), (W′), (U*), (V*), (W*) are as follows: 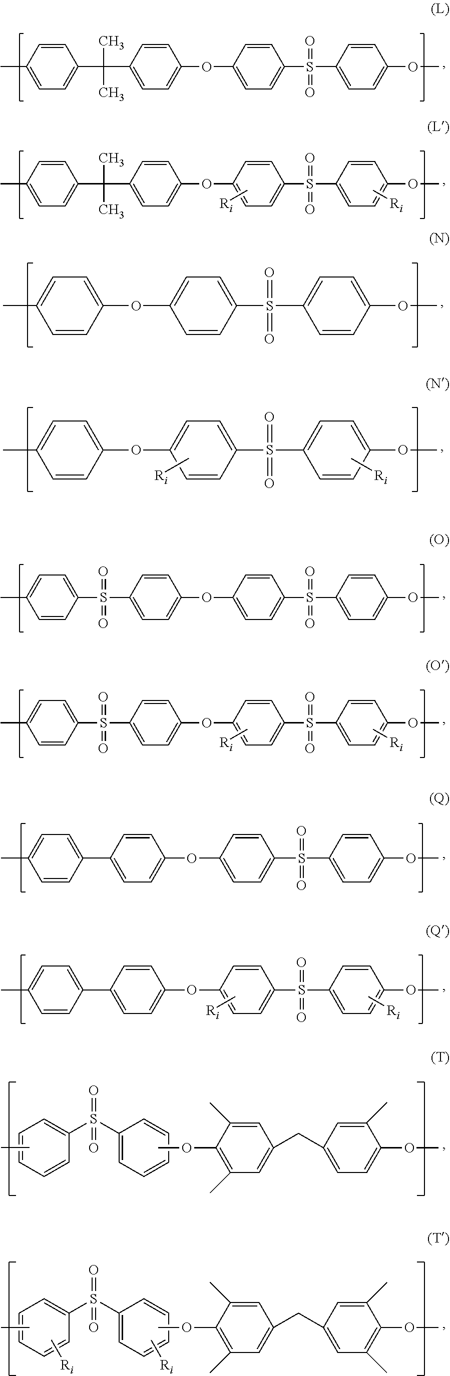 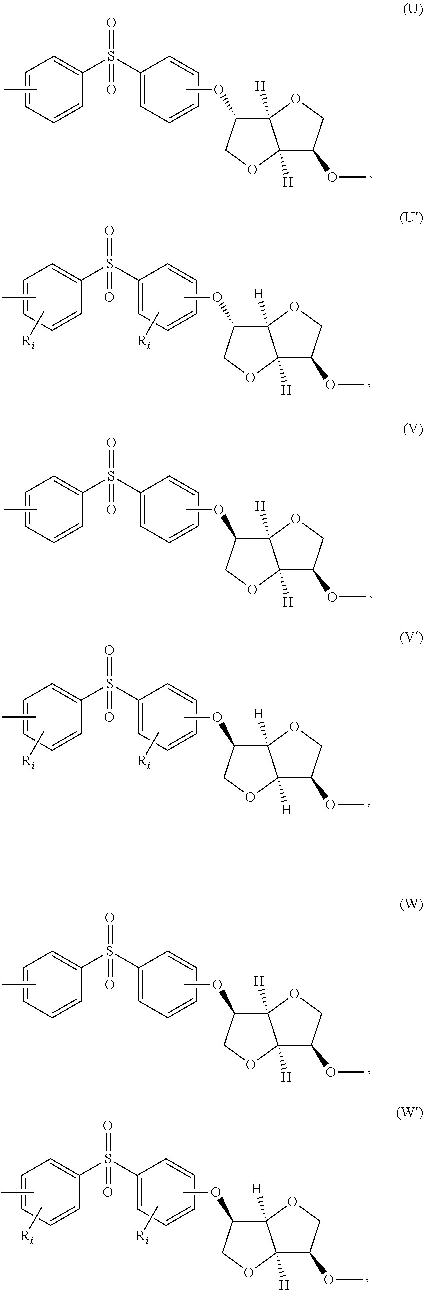 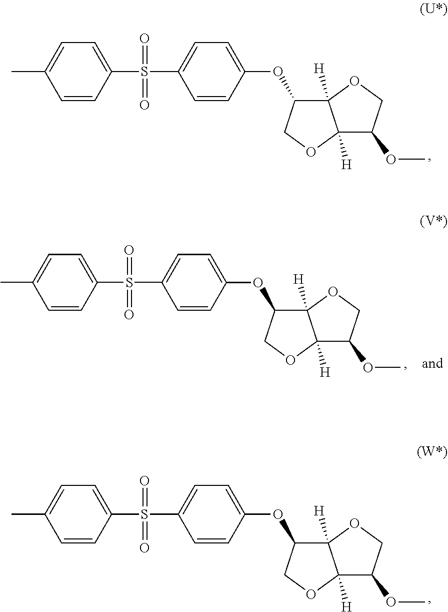
wherein:
each R is independently selected from the group consisting of halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine, and quaternary ammonium; and
each i is independently an integer of 1 to 4.

2. The process of claim 1, wherein:
the aromatic diol monomers (AA) are selected from the group consisting of 4,4′-biphenol, bisphenol A, bisphenol S, isosorbide, isomannide, isoidide, tetramethyl bisphenol F, hydroquinone, and any combination thereof, preferably selected from the group consisting of 4,4′-biphenol, bisphenol A, bisphenol S, tetramethyl bisphenol F, hydroquinone, and any combination thereof, and/or
the aromatic dihalo monomer (BB) is selected from the group consisting of 4,4′-difluorodiphenylsulfone (DFDPS), 4,4′-dichlorodiphenylsulphone (DCDPS), disulfonated DCDPS, disulfonated DFDPS, and any combination thereof, preferably selected from the group consisting of DCDPS, disulfonated DCDPS, and combination thereof; and/or
the polar aprotic solvent (S) is selected from the group consisting of 1,3-dimethyl-2-imidazolidinone (DMI), dimethylsulfoxide (DMSO), dimethylsulfone (DMSO2), diphenylsulfone, diethylsulfoxide, diethylsulfone, diisopropylsulfone, tetrahydrothiophene-1,1-dioxide (commonly called tetramethylene sulfone or sulfolane), N-alkyl-2-pyrrolidone like N-Methyl-2-pyrrolidone (NMP), N-butylpyrrolidinone (NBP), N-ethylpyrrolidone (NEP), N,N′-dimethylacetamide (DMAc), N,N′-dimethylpropyleneurea (DMPU), dimethylformamide (DMF), tetrahydrothiophene-1-monoxide, and any combination thereof.

3. The process of claim 1, wherein said polyarylethersulfone (P1) is derived by condensation from at least one aromatic diol monomer (AA′) and at least one aromatic dihalo monomer (BB′), and wherein:
the added aromatic diol monomer (AA) is the same or different than the aromatic diol monomer (AA′); and/or
the added aromatic dihalo monomers (BB) are the same or different than the aromatic dihalo monomer (BB′).

4. (canceled)

5. The process of claim 1, wherein the polyarylethersulfone (P1) is selected from the group consisting of
PPSU,
PSU,
PES,
sulfonated PSU
sulfonated PES,
sulfonated PPSU,
any polymer derived from a diol monomer selected from isosorbide and/or tetramethyl bisphenol F and a dihalo monomer selected from sulfonated dihalodiphenylsulfone and/or dihalodiphenylsulfone,
any copolymer derived from at least two diols selected from biphenol, bisphenol A, bisphenol S, isosorbide, tetramethyl bisphenol F, and/or hydroquinone and a dihalo monomer selected from sulfonated dihalodiphenylsulfone and/or dihalodiphenylsulfone,
a block polymer in the form A-B or A-B-A, comprising at least one sulfone polymer block having one recurring unit selected from those of PPSU, sPPSU, PSU, sPSU, PES, sPES, and at least one block having one recurring unit made from tetramethyl bisphenol F and sulfonated or non-sulfonated dihalodiphenylsulfone or from a 1,4:3,6-dianhydrohexitol sugar diol and sulfonated or non-sulfonated dihalodiphenylsulfone;
a block copolymer in the form A-B or A-B-A, comprising at least one block polymer having one recurring unit selected from those of PPSU, sPPSU, PSU, sPSU, PES, sPES, and at least one polyalkylene oxide or polyvinylpyrrolidone (PVP) block, such as a PEG block, PPG block or a PVP block; and
any combination of two or more thereof.

6. The process of claim 1, wherein the recycled polymeric material further comprises another polymer (P3) which is different than the polyarylethersulfone (P1), and
wherein the recycled polymeric material includes
a blend of the polyarylethersulfone (P1) and the other polymer (P3) and/or
a block copolymer comprising at least one block of the polyarylethersulfone (P1) and at least one block of the other polymer (P3).

7. The process of claim 1, wherein the recycled polymeric material further comprises a non-polymeric filler, such as particulate mineral fillers, carbon fibers, and/or glass fibers.

8. The process of claim 1, wherein the recycled polymeric material comprises at least one material selected from the group consisting of post-consumer polymeric articles, post-industrial polymeric articles including article scraps, off-specification polyarylethersulfone products; and any combination thereof.

9. The process of claim 1, wherein
the added polyarylethersulfone (P1) is a PES, the formed polyarylethersulfone (P2) is a PES homopolymer or copolymer, and the at least one monomer (M) added to the reactor vessel is Bisphenol S; or
the added polyarylethersulfones (P1) is a PSU, the formed polyarylethersulfone (P2) is a PSU homopolymer or copolymer, and the at least one monomer (M) added to the reactor vessel is Bisphenol A; or
the added polyarylethersulfone (P1) is a PPSU, the formed polyarylethersulfone (P2) is a PPSU homopolymer or copolymer, and the at least one monomer (M) added to the reactor vessel is 4,4′-biphenol.

10. The process of claim 1, wherein:
the polyarylethersulfone (P2) has an Mw (P2) which is within +/−35% of the Mw_{(P1)} of the polyarylethersulfone (P1), wherein the Mw_{(P1)} and Mw_{(P2)} are measured via GPC method using methylene chloride as the mobile phase and calibrated with polystyrene standards; and/or
the polyarylethersulfone (P2) has a PDI_{P2} value which is within +/−35% of the PDI_{P1} value of the polyarylethersulfone (P1), wherein a PDI is the ratio of weight average molecular weight (Mw) over the number average molecular weight (Mn), each of Mw and Mn being measured via GPC method using methylene chloride as mobile phase and calibrated with polystyrene standards.

11. The process of claim 1, wherein the polyarylethersulfone (P2) has an Mw_{(P2)} of at least 40 kDa, said Mw_{(P2)} being measured via GPC method using methylene chloride as mobile phase and calibrated with polystyrene standards.

12. The process of claim 1, wherein the recycled polymeric material comprising the polyarylethersulfone (P1) is added to the reactor vessel in solid forms, or in form of a solution or slurry in which at least part of the polyarylethersulfone (P1) is dissolved before being added to the reactor vessel.

13. The process of claim 1, wherein
the separating step includes coagulation of the polyarylethersulfone (P2), and/or
the process further comprises at least one of the following steps, between the reaction step and the separation step:
cooling the reaction medium;
adding a solvent (S_{q}), which is the same or different than the polar aprotic solvent (S), to quench the reaction medium; and/or
adding an end-capping agent to convert hydroxyl end groups of the formed polyarylethersulfone (P2) to less reactive end groups.

14. The process of claim 1, being carried out with a recycle ratio of polyarylethersulfone (P1) in the reaction medium from 100 wt. % to 1 wt. %, said recycle ratio is calculated as the ratio of the weight of the added polyarylethersulfone (P1) based on the combined weight of the added polyarylethersulfone (P1) and the maximum weight of the PAES polymer which would be theoretically produced based on the equimolar stoichiometry of polycondensation of monomers (AA) and (BB) when both diol monomer (AA) and dihalo monomer (BB) are added to the reactor medium.

15. The process of claim 1, wherein the at least one monomer (M) comprises at least one aromatic diol monomer (AA), and
wherein
the condensation reaction is being carried out with a molar ratio of the alkali salt-forming salt to the diol monomer (AA) being at least 1 and at most 2, and/or
the diol (AA) and the alkali salt-forming agent (A) are added to the reactor vessel in the form of an alkali salt (AAA) of the diol (AA).

16. The process of claim 1, wherein the reaction temperature is
at least 160° C.; and/or
at most 350° C.

17. A polyarylethersulfone (P2) obtained by the process of claim 1.

18. An article comprising the polyarylethersulfone (P2) of claim 17.

19. The article of claim 18, selected from the group consisting of membranes, fibers, sheets, solution-processed films, solution-processed monofilaments, and any combination thereof.

20. The process of claim 1, wherein the recycled polymeric material comprises at least an article selected from the group consisting of membranes, automotive components, electronic components, consumer product components such as baby bottles, composites, battery components, and any combinations thereof.

21. The process of claim 6, wherein the other polymer (P3) is a pore-forming polymer selected from the group consisting of polyvinylpyrrolidone (PVP), a polyalkylene oxide and combination thereof.
